(19) United States
(12) Patent Application Publication
(10) Pub. No.: US 2023/0282400 A1
(43) Pub. Date: Sep. 7, 2023

(54) MAGNET STRUCTURES COMPRISING A HIGH TEMPERATURE SUPERCONDUCTOR (HTS) CABLE IN GROOVE

(71) Applicants: Massachusetts Institute of Technology, Cambridge, MA (US); Commonwealth Fusion Systems LLC, Cambridge, MA (US)

(72) Inventors: Alexey RADOVINSKY, Cambridge, MA (US); Brian LABOMBARD, Belmont, MA (US); Robert MUMGAARD, Boston, MA (US)

(73) Assignees: Massachusetts Institute of Technology, Cambridge, MA (US); Commonwealth Fusion Systems LLC, Cambridge, MA (US)

(21) Appl. No.: 18/008,279

(22) PCT Filed: May 11, 2021
(86) PCT No.: PCT/US2021/031699

§ 371 Date: Dec. 5, 2022

Related U.S. Application Data
(60) Provisional application No. 63/044,574, filed on Jun. 26, 2020.

(51) Int. Cl. H01F 6/06; B23K 1/00

(52) U.S. Cl. CPC H01F 6/06; B23K 1/0016; H01F 41/048

(57) ABSTRACT

A method includes inserting a high temperature superconductor (HTS) cable into a groove of a support structure; and flowing a molten metal into the HTS cable while the HTS cable is in the groove. A magnet structure includes a support structure having a groove; and a high temperature superconductor (HTS) cable comprising a metal at least partially filling the HTS cable, the HTS cable being disposed in the groove.

### CROSS REFERENCE TO RELATED APPLICATIONS

The present application claims the benefit under 35 U.S.C. § 119(e) of provisional application 63/044,574, filed Jun. 26, 2020, which is hereby incorporated by reference in its entirety.

### FIELD

The concepts described herein generally relates to superconducting electromagnets (magnets), and in particular to superconducting magnets comprising a cable including a high temperature superconductor.

### BACKGROUND

Superconducting magnets may be used in a variety of applications to generate a high magnetic field. Some examples of applications include thermonuclear fusion reactors, motors and generators, magnetic resonance imaging (MRI) machines, among many others. To generate a high magnetic field, superconducting magnets may be formed of many turns of an electrical conductor (conductor). When a current flows through the conductor, a magnetic field is generated in accordance with Maxwell's equations. Conductors that are not superconducting have a non-zero electrical resistance, which leads to power loss in the conductor. By contrast, an ideal superconductor has exactly zero electrical resistance. Using a superconductor as the conductor of a magnet improves the efficiency of the magnet, permits reaching higher magnetic fields and reduces heating.

### SUMMARY

Some embodiments relate to a method, comprising: inserting a high temperature superconductor (HTS) cable into a groove of a support structure; and flowing a molten metal into the HTS cable while the HTS cable is in the groove.

The molten metal may be a molten solder and flowing the molten metal into the HTS cable comprises flowing the molten solder into the cable.

Inserting the HTS cable into the groove may comprise inserting the HTS cable into the groove into a spiral-shape.

The method may further comprise cooling the molten metal to solidify the molten metal.

The method may further comprise inserting a second HTS cable into a second groove of a second support structure and flowing a second molten metal into the second HTS cable while the second HTS cable is in the groove.

The method may further comprise attaching the first support structure to the second support structure.

The method may further comprise electrically connecting the HTS cable with the second HTS cable.

Some embodiments relate to a magnet structure, comprising: a support structure having a groove; and an HTS cable comprising a metal at least partially filling the HTS cable, the HTS cable being disposed in the groove.

The metal may comprise solder.

A shape of the HTS cable may conform to a shape of the groove.

The HTS cable may comprise at least one HTS tape stack.

The HTS cable may comprise a plurality of channels and a plurality of HTS tape stacks disposed in respective channels of the plurality of channels.

The HTS cable may comprise a former separating at least first and second HTS tape stacks of the plurality of HTS tape stacks.

The former may comprise an electrically conductive metal.

The magnet structure may further comprise an electrical insulator insulating sections of the former from each other.

The conductive metal may comprise copper or steel.

The HTS cable comprise a cooling channel.

The at least one HTS tape stack may be twisted along a length of the HTS cable.

The support structure may comprise an electrically conductive material.

The HTS cable may have a spiral shape in the groove.

The HTS cable may have a plurality of turns, and respective turns of the plurality of turns may be electrically coupled to one another through the support structure.

The magnet structure may further comprise a second support structure having a second groove; and a second HTS cable comprising a second metal at least partially filling the second HTS cable, the second HTS cable being disposed in the second groove, wherein the HTS cable is electrically connected to the second HTS cable.

The HTS cable may comprise a jacket and an HTS tape within the jacket.

The jacket and the HTS tape may extend along a length of the HTS cable.

The support structure may comprise a plate.

The HTS cable may comprise an HTS tape stack that can slip along a length of the HTS cable when the HTS cable is inserted into the groove.

Flowing a molten metal into the HTS cable may comprise flowing the molten metal into a channel of the HTS cable.

### BRIEF DESCRIPTION OF THE DRAWINGS

Non-limiting embodiments which illustrate concepts will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment shown where illustration is not necessary to allow those of ordinary skill in the art to understand the concepts and embodiments being described. In the figures:

FIG. 1 illustrates a method of forming a high temperature superconductor (HTS) magnet.

FIG. 2A illustrates an example of a cross section of a support structure.

FIG. 2B shows a top-view of a support structure.

FIG. 2C illustrates that an HTS cable may be placed in the groove 220.

FIG. 2D illustrates the filling of the HTS cable with a molten metal.

FIG. 3A shows an example in which a cap is disposed on top of the HTS cable in the groove of the support structure.

FIGS. 3B1 and 3B2 illustrate the support structures may each have layer-wound scheme with a cylindrical geometry, with the top of the support structure having the groove facing either outwardly (FIG. 3B1) or inwardly (FIG. 3B2).

FIG. 3B3 shows an example of a corkscrew-shaped HTS cable.

FIG. 3C shows a support structure with a pancake-wound scheme.

FIG. 3D shows configuring the shape of the no-insulation shell so that it is parallel to flux lines of the variable external magnetic field.

FIG. 3E shows one example of segmented HTS cable.

FIG. 3F shows one example of a non-segmented HTS cable.

FIG. 3G shows a plot of losses vs frequency for a variety of different formers.

FIG. 3H shows an example of an HTS cable in which the cooling channel is eliminated and replaced by an extension of the segmented former.

FIG. 3I shows TSTC cable as an example of the HTS cable.

FIG. 3J shows a CROCO cable as an example of the HTS cable.

FIG. 3K shows an example of a filamentized table that may be used for the HTS tape stack.

FIG. 4 shows an example of an HTS cable having a single HTS tape stack.

FIG. 5 shows an example of an HTS cable having a plurality of HTS tape stacks disposed in respective channels of a former.

FIGS. 6A and 6B show a cable comprises a former having a plurality of channels provided therein.

FIGS. 7A and 7B form a flow diagram made up of a sequence of processing elements which form an illustrative embodiment of a metal-filling process in accordance with the concepts described herein.

FIG. 8 shows an apparatus for filling the cable with solder using a vacuum-pressure technique.

FIG. 9 shows an example of structures within an HTS cable.

FIG. 10 shows an example of an HTS tape.

### DETAILED DESCRIPTION

High temperature superconductors (HTS) can be advantageous in superconducting magnets as they remain superconducting at higher temperatures than low temperature superconductors, and thus do not need to be cooled to as low of a temperature to remain superconducting. As used herein, the phrase “HTS materials” or “HTS superconductors” and the like refer to superconducting materials having a critical temperature above 30° K at self-field. One example of a ceramic HTS is rare-earth barium copper oxide (REBCO). HTS superconductors may be formed in tapes or tape stacks that include several layers of various materials. An HTS magnet is a magnet that includes an HTS material to carry at least a portion of the current.

### HTS Materials and Magnet Design Considerations

High Temperature Superconductors (HTS) open new opportunities for building high-field magnets for multiple applications.

Some features of HTS and HTS REBCO tape in particular, are:
small (compared with Low Temperature Superconductors (LTS)) critical current sensitivity to the operating temperature, permitting larger operating temperature margins;
higher operating temperatures than in LTS, at which the heat capacity of materials comprising the cold mass of the magnet is significantly higher than at LTS-compatible temperatures and consequently smaller sensitivity to local heating, provided sufficient cooling to cap associated temperature rise;
compatibility with No-Insulation (NI) design principles due to good current sharing between bundled HTS REBCO tapes and between the tapes and surrounding electrically conducting media comprising cold mass structure and co-wound stabilizers;
possible solder impregnation, significantly enhancing current sharing, leading to much better tolerance and stability to quench, and under certain conditions guaranteed recovery from the quench;
large, compared with LTS, permitted intrinsic strains;
NI winding specific small (<˜1 V) voltages developed in the magnet at typical modes of operation, as well as during the quench; this does not require high-voltage electrical insulation, as for the LTS magnets.

This disclosure describes a class of innovative magnet designs which may use HTS materials technology, and provides examples of applications, potentially benefiting from using this class of magnet design.

A simplified classification of superconducting magnets, relevant to the choice of the winding scheme of the considered here type can be presented in the following form. Magnets can be subdivided into two major groups:
Constant current magnets, usually referred to as direct-current (DC) magnets;
Variable current magnets, usually referred to as alternating-current (AC) magnets.

The techniques and apparatus described herein apply in particular to DC magnets, but are not limited to DC magnets and can also apply to AC magnets.

In this respect magnets can be subdivided into the following subgroups:
Group 1: DC magnets operating in constant external field environment;
Group 2: DC magnets operating in the environment, superposing weak variable external magnetic fields on top of the constant self-field of the DC magnet;
Group 3: DC magnets operating in the environment with variable external magnetic fields of magnitude of the same order, as the self-field of the DC magnet.

Typical representatives of the magnets belonging to these groups include but are not limited to:
Group 1: MRI and NMR magnets, multipole focusing magnets in Linear Accelerators (Linacs), magnets of synchrocyclotrons, field coils in induction motors and generators, widely used in wind power systems;
Group 2: Toroidal Field (TF) magnets in tokamak fusion reactors (tokamaks);
Group 3: Background field coils for various test facilities and high energy physics experiments.

All three groups can benefit from the concepts, structures and techniques described herein. The applicability of these engineering solutions may be limited by the balance between the AC losses in the magnet and its cooling power, although these limitations are more prohibitive for the magnets of Group 3.

There are four types of AC (power) losses that may be considered for a magnet comprising one or more HTS tape stacks: ferromagnetic, hysteresis, coupling, and caused by eddy currents.
1. Ferromagnetic losses are associated with the heat generated by magnetization or de-magnetization of ferromagnetic elements like iron. If no materials in the cable are ferromagnetic these losses can be ignored.
2. Hysteresis losses are similar to ferromagnetic losses but pertain only to type II superconductors. Unlike type I superconductors, type II superconductors may be penetrated by magnetic field lines. As the applied magnetic field within the material changes, losses occur in proportion to the frequency and magnitude of the change, as well as the critical current density (Jc) of the tape and the width of the tape. Usually volumetric hysteresis power losses are evaluated using Bean model, but the concepts described herein are not limited in this respect.
3. Coupling losses are created by currents running between tapes and tape stacks. Coupling losses between tapes in the stack can happen for many reasons. For example, the critical current (Ic) of each tape varies along its length, so if a high average-Ic tape has a relative low-Ic spot, some current may spill into other tapes in the stack. In a single-stack cable stack-to-stack current sharing is not an issue, and in a multi-stack cable, stack-to-stack sharing can be blocked by insulation. In that case tape parallel to the field will generally have much higher Ic than a tape closer to perpendicular, and a twisting cable will cause each stack to have a constantly varying orientation with respect to magnetic field.
4. Voltages are induced in the cable (among other structures) by the changing magnetic field environment, as described by Faraday's law. The voltages drive eddy currents in inverse proportion to the resistance of the current path, and so the currents are almost entirely developed through the copper and HTS.

There is little that can be done to mitigate ferromagnetic and hysteresis losses, though they are expected to be small in magnets comprising one or more HTS tape stacks. Coupling losses in the HTS tape stack can be reduced by reducing the width of the superconducting tape in the stack and the overall cross-sectional dimensions of the tape stack.

In some embodiments, the techniques and apparatus described herein reduce the eddy-current AC losses in a viable superconducting magnet, which can facilitate meeting practical engineering requirements.

In some applications, a magnet may need to meet the following requirements:
Magnet can operate at a constant operating current at high, up to 20 T, magnetic self-field, being able to sustain eddy-current heating caused by ramping or oscillations of limited by the magnitude and frequency range external magnetic fields;
Magnet can operate at elevated cryogenic temperature, above 10 K; it can sustain magnetic quench, optionally in a passive mode, i.e., without interference by any kind of quench protection systems.

Two usual ways of reducing eddy-current losses in magnets are:
Segmentation of the components comprising the magnet in order to reduce the current loops of trapped magnetic flux, (e.g. as may be) done in transformers with laminated iron sheets;
Reducing or complete elimination of copper or other high electrical conductivity materials.

One approach to the magnet design is by using so-called no-insulation (NI) winding schemes. In this case the magnet is comprised of a cable installed in such a way that there is no continuous turn-to-turn insulation, which permits limited turn-to-turn current sharing. A simplified representation of the no-insulation scheme is by presenting it as a set of parallel superconducting cables installed in a thin high electrical resistivity matrix. Good electrical conductivity is established between respective turns of the magnet. One advantage of HTS no-insulation magnets is that they are passively resilient to quench (in which a region of HTS superconductor becomes resistive). Another advantage is that an NI magnet comprising one or more superconducting cables may need little or no copper stabilizer. These features make an NI winding scheme attractive for applications in need of a DC superconducting magnet working in the presence of variable external magnetic fields.

### HTS Cables in a Groove of a Support Structure

There are a number of ways in which HTS tapes may be formed into a magnet. In some embodiments, an HTS superconductor may be disposed in a cable. Under certain conditions an HTS cable can be bent into a variety of shapes. An HTS cable is a cable having an HTS superconductor to carry current along the length of the HTS cable. An HTS cable may be insulated or non-insulated. An HTS cable that is non-insulated may enable forming an NI magnet.

One consequence of producing a high magnetic field is that large forces (Lorentz forces) are produced on the conductor carrying the current. It is thus desirable to provide a magnet having a structure that is sufficiently structurally robust to be able to withstand such forces.

In some embodiments, an HTS magnet may be formed by placing an HTS cable in a groove of a support structure that defines a desired shape for the HTS cable. At this stage the HTS cable can be bent into a desired shape without damaging the HTS tape stack, as the HTS tape stack is not fixed in place and can slip along a length of the HTS cable as the HTS cable is bent. The HTS cable includes a jacket surrounding the HTS tape and a channel for receiving a molten metal. Once the HTS cable is bent into its desired shape, molten metal (e.g., a solder) may then be flowed into the cable while the cable is within the groove of the support structure. When the molten metal cools, the HTS cable is thereby “frozen” into its final shape within the groove of the support structure, and the HTS tape stack can no longer move to a significant degree within the HTS cable. Advantageously, the support structure may provide mechanical support for the HTS magnet, allowing it to withstand the forces created during operation of the magnet.

It should be appreciated that to promote clarity in the drawings and text of the concepts, structures and techniques described herein example embodiments of a cable bent into a spiral shape in a single plane is described herein. However, after reading the description provided herein, those of ordinary skill in the art will appreciate that cables may be bent into any desired shape including shapes defined by curved surfaces (e.g. such as may be required to form complex multi-dimensional curved structures). Non-limiting examples of some curved surfaces are described hereinbelow.

It should also be appreciated that high field superconducting magnets often comprise multiple cable turns grouped in a multi-layer arrangement (i.e. the magnets are comprised of multiple layers). The turns may be closely spaced. In embodiments in which a high field superconducting magnet is formed by turns of an HTS, HTS tape, or HTS tape stack arranged in flat layers (e.g. such that contacting surfaces of the layers are orthogonal to a central longitudinal axis of the magnet about which the layers are disposed), such an arrangement may be referred to as “pancake-wound” or even more simply “a pancake.” Thus, a pancake includes both an HTS component and a structural component for housing the HTS. If a magnet is formed by layers with turns (e.g. such that contacting surfaces of the layers are parallel to a central longitudinal axis of the magnet about which the layers are disposed), such an arrangement may be referred to as a “a layer-wound scheme” or simply “a layered configuration” or even more simply “layered.”

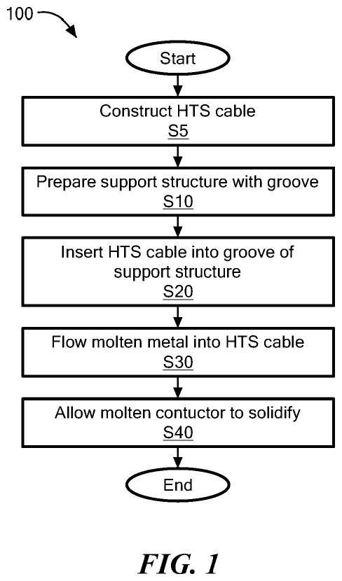

FIG. 1 illustrates a method 100 of forming an HTS magnet, according to some embodiments. In step S5, an HTS cable may be constructed. The HTS cable may be constructed using any suitable manufacturing technique, and having any suitable structure, examples of which are described herein. A channel in the HTS cable may not be filled with a molten metal (e.g. solder) at this step. For example, the channel may be left empty to accommodate filling by a molten metal at a later step. In step S10, a support structure may be formed having a groove. In some embodiments, the support structure may be a plate. However, the apparatus and techniques described herein are not limited in this respect, as the support structure may have shapes other than that of a plate. The support structure may be formed of a mechanically rigid material. In some embodiments, the support structure may be formed of an electrically conducting material. A support structure comprising an electrically conducting material between turns of the HTS cable may facilitate forming a no-insulation (NI) magnet. In some embodiments, the support structure may be formed of a metal. An example of a metal that provides both mechanical rigidity and that is electrically conducting is steel. Suitable types of steel include NITRONIC 40 and 50, for example. However, the apparatus and techniques described herein are not limited in this respect, as the support structure may be formed of other metals or non-metals, or a combination of various materials in various layers may be used. The support structure may have a groove formed therein to accommodate an HTS cable. For example, if the support structure is a plate, a first surface of the plate may have a groove formed therein. In some embodiments, the groove may have a spiral-shape and/or may be shaped to accommodate an HTS cable in a spiral-shape.

In step S20, an HTS cable may be inserted into the groove of the support structure. If the groove has a spiral-shape, the HTS cable may be wound into the spiral shape and pressed into the groove. Prior to placing the cable into the groove in the support structure a conductive material may be disposed in the groove or on the outside of the HTS cable, which may reduce the contact resistance between the HTS cable and the support structure. For example, the conductive material may be a malleable material such as indium, or a material that flows when heat is applied, such as solder. The solder may be heated and flowed into the grove, and then solidified. In some embodiments there may be no conductive material between the support structure and the outside of the HTS cable (e.g., any space between the support structure and the HTS cable may be left empty). In the latter case the reliance is on the current sharing between the HTS cable and the support structure via contact resistance between them.

In step S30, a molten metal, such as a solder, may be flowed into the HTS cable while the HTS cable is within the groove. For example, as described in further detail herein, an apparatus may be connected to the HTS cable which heats the molten metal and flows the molten metal into one or more channels within the HTS cable.

In some embodiments the HTS cable can be placed into the groove in the support structure without adding any material between them. In step 30 molten material will flow into this space and form electrically conducting layer between the HTS cable and the support structure.

In step S40, the molten metal may be allowed to cool and solidify. This may be done by removing a source of heat or otherwise cooling the HTS cable.

Once the molten metal solidifies the HTS cable is “frozen” or “locked” into its final shape. Thereafter, the HTS cable may not be bent significantly without breaking it. Accordingly, the resulting structure may be an HTS magnet having an HTS cable with solder in the groove of a support structure. Such a structure may be used as an HTS magnet or a plurality of such structures may be joined together (e.g., stacked) to form an HTS magnet having an even greater number of turns, with suitable electrical interconnections between the respective structures.

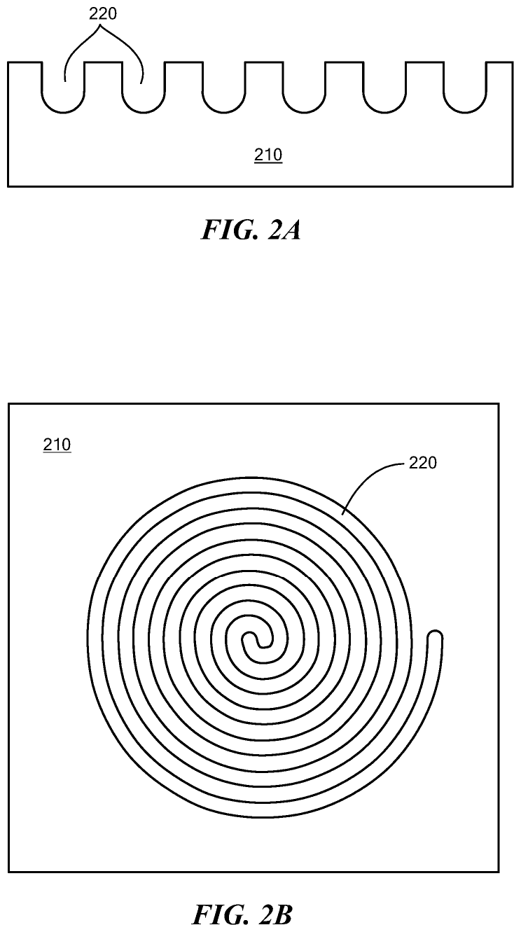

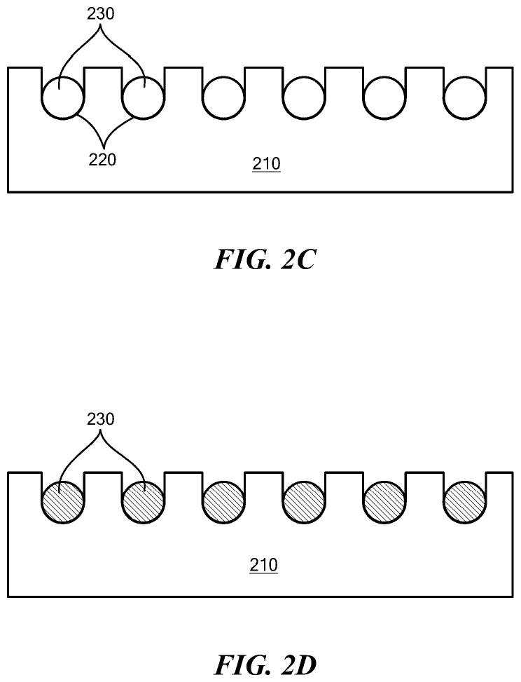

FIG. 2A illustrates an example of a cross section of a support structure 210, according to some embodiments. In this example, the support structure 210 has a groove 220 on its top surface. The groove 220 may have a spiral shape, such as that illustrated in FIG. 2B, which shows a top-view of a support structure 210. It should be appreciated that the groove 220 may have any suitable number of turns, where the term “turn” refers to one revolution about a center point. FIGS. 2A and 2B illustrate the result of step S10 of FIG. 1 according to some embodiments.

FIG. 2C illustrates that an HTS cable 230 may be placed in the groove 220. FIG. 2C shows the result of step S20 of FIG. 1, according to some embodiments. As shown in FIG. 2C, the shape of the groove 220 may be formed to match the shape of the HTS cable 230. For example, if the HTS cable 230 has a circular cross-section, as illustrated in FIG. 2C, the groove may have a semi-circular cross-section with a radius that closely matches the radius of the HTS cable 230. In embodiments, the radii of the cable and the groove (or more broadly, the dimensions of the cable and groove when either the cable or groove are not provided having a circular or semi-circular cross-sectional shape) may be selected to provide a press fit. In other embodiments, the cable and groove radii (or cable and groove dimensions) may be selected to provide an interference fit. In other embodiments, the cable and groove radii (or cable and groove dimensions) are selected to provide a clearance fit. In still other embodiments, the cable and groove radii (or cable and groove dimensions) are selected to provide a transition fit. However, the techniques and apparatus described herein are not limited in this respect, as the HTS cable and groove cross-section may have any regular or irregular shape, such as a square shape, a rectangular shape, an oval shape, a triangular shape, etc.

FIG. 2D illustrates the filling of the HTS cable 230 with a molten metal in step S30 of FIG. 1, according to some embodiments. The filling of the HTS cable 230 with a molten metal is schematically illustrated in FIG. 2D with hashing, however, it should be appreciated that only a portion of the HTS cable 230 may be filled with molten metal. For example, as described in further detail below, one or more channels in the HTS cable 230 may be filled with the molten metal. The molten metal may then be allowed to solidify, as discussed above. The structure as illustrated in FIG. 2D may then be used as an HTS magnet, or may be connected to other structures such as that shown in FIG. 2D to form a composite or stacked HTS magnet.

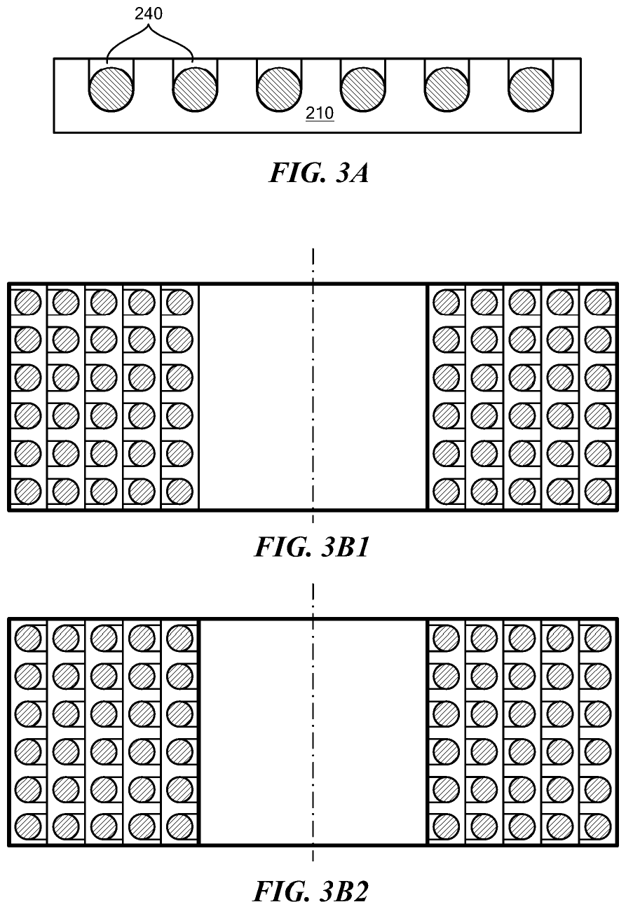

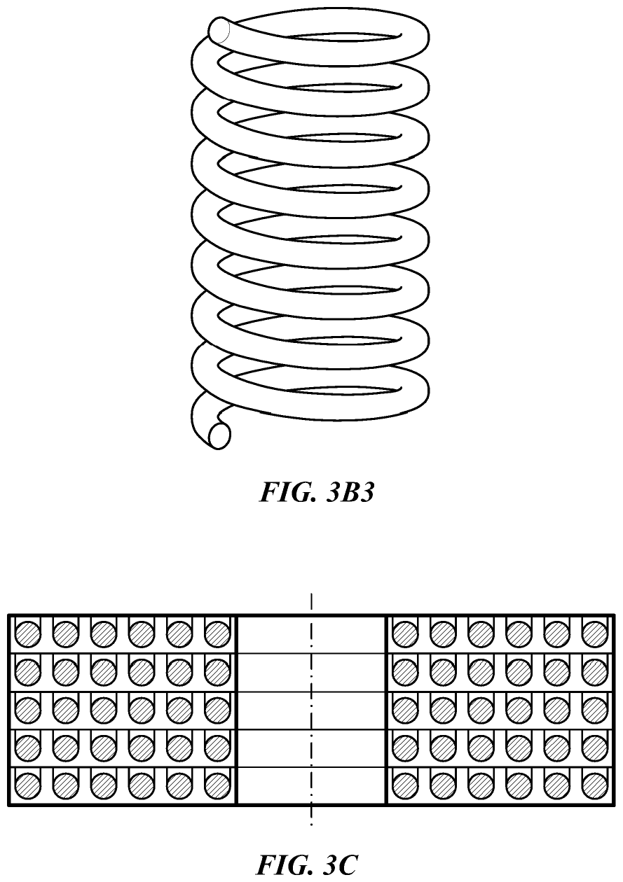

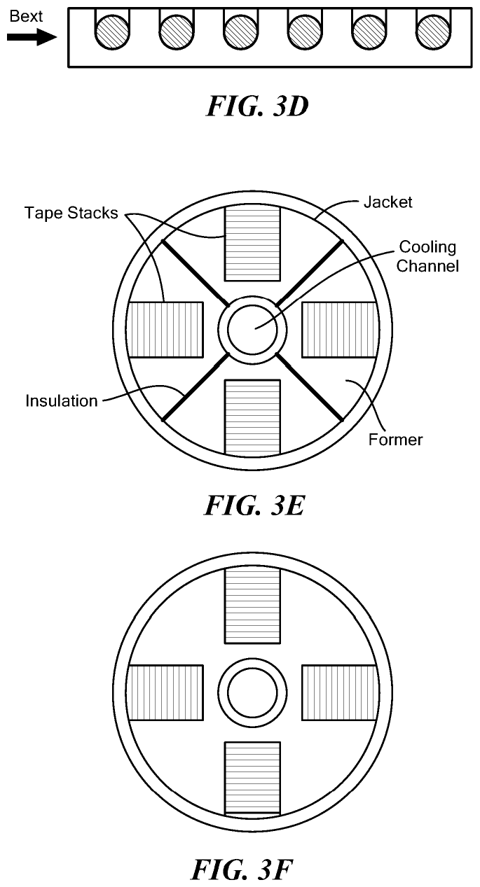

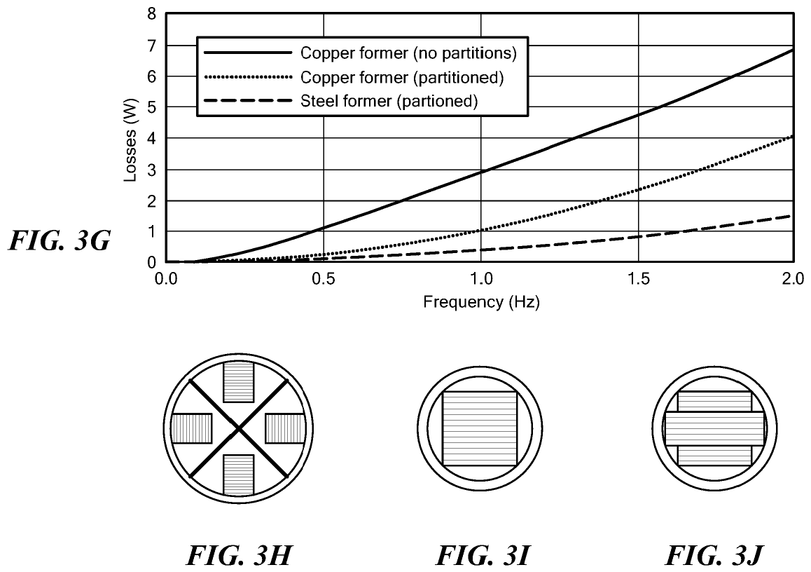

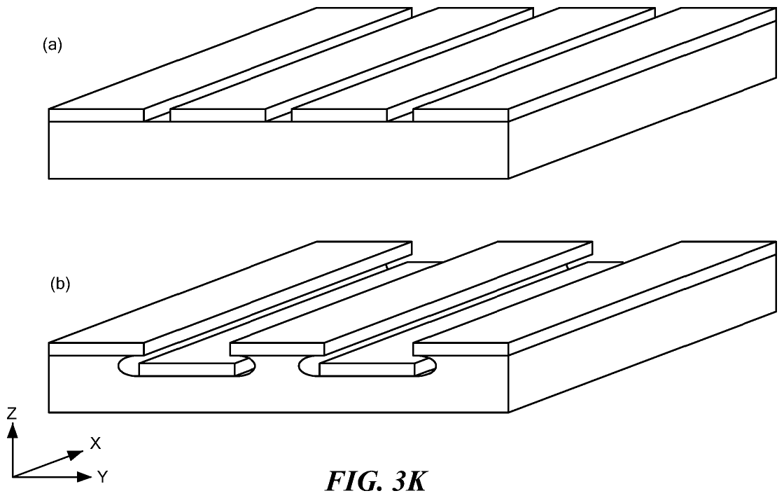

FIG. 3A shows an example in which a cap 240 is disposed over the HTS cable 230 in the groove 220 of the support structure 210. The cap 240 may hold or otherwise secure the HTS cable 230 in place in the groove 220. The cap 240 may be formed of any conductive or non-conductive material. In some embodiments, cap 240 may be formed of the same material as that of the support structure (e.g., steel). The cap 240 may be secured to the support structure in any suitable way. In some embodiments, the cap 240 may be welded by its edges to the edges of the groove 220 of the support structure, as shown in FIG. 3A. Disposing solder or other molten metal between the outside of the HTS cable and the support structure can be done before or after installing and securing the caps.

As discussed above, a plurality of pancakes may be joined together (e.g., stacked) to form an HTS magnet. They may be arranged in a multi-layered arrangement of a layer-wound (FIG. 3B1, 3B2) or a pancake-wound (FIG. 3C) scheme respectively. As shown in FIGS. 3B1 and 3B2, the support structures may each have a cylindrical geometry, with the top of the support structure having the groove facing either outwardly (FIG. 3B1) or inwardly (FIG. 3B2). As shown in FIGS. 3B1 and 3B2, the support structures may be nested within one another. The surface of each cylindrical-shaped support structure may have a groove extending along the surface in a corkscrew shape to accommodate a corkscrew-shaped HTS cable. An example of a corkscrew-shaped HTS cable is shown in FIG. 3B3. The cylindrical structures having a cylindrical support structure and an HTS cable in a groove of the support structure may be formed separately and then inserted into or on the outside of each other to form the nested cylinder structures shown. Insertion of the cylindrical layers can be done by a “shrink-fit” procedure, e.g., by heating/cooling layers, to reduce or eliminate the gap between them. Alternatively, they can be inserted in a different way to reduce the gap, or inserted with a small gap. The gap may be filed by glass-fiber cloth or other suitable material and then the whole assembly may be filled (e.g., vacuum impregnated) with epoxy, forming a layer-to-layer insulation between adjacent cylinders. Alternately, layer-to-layer insulation can be formed by prefabricated solid sheets of Kapton, G10 or G11. HTS cables in adjacent cylinders may be connected to one another by suitable electrical joints. When a plurality of pancakes are stacked, as shown in FIG. 3C, connections may be made between the pancakes by electrically conductive joint structures. Such joint structures may be superconducting or non-superconducting. Apart from the joint structures, the interface between respective pancakes (e.g., flat support structures) or layers (e.g., cylindrical support structures) may be an insulating material.

There are two major mechanisms of eddy-current superconducting cable losses in the no-insulation magnets:
Eddy currents formed by loops formed by superconducting cables, shunted at the ends through the high electrical resistivity matrix; and
Eddy currents in the superconducting cable. Mitigating these losses is specific to the design of the cable and is discussed below.

Eddies in the matrix are instigated primarily by variable external magnetic fields, normal to the thin no-insulation shell (layer, pancake, etc.).

In the case of a well-defined shape of the variable external magnetic field these losses can be mitigated by adjusting the shape of the no-insulation shell so that it is parallel to flux lines of the variable external magnetic field (FIG. 3D).

### Examples of HTS Cables

HTS cable 230 may be structured according to a number of different designs. There have been a number of HTS REBCO-based cable designs proposed and developed. Many of them have been designed to reduce AC coupling losses. This may be accomplished by so-called transposition of the tape in the cable. This transposition is done in many different ways.

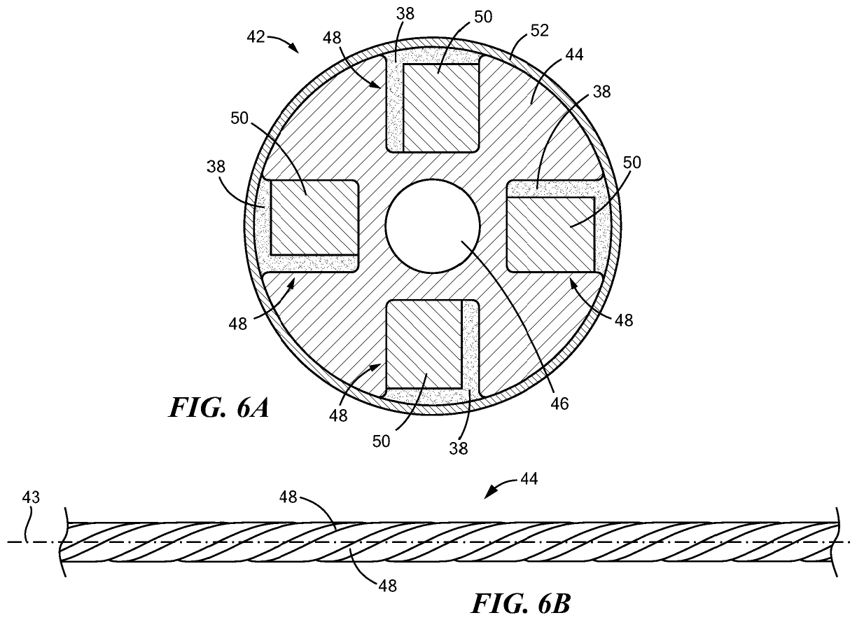

One example of HTS cable 230 is a so-called PIT VIPER cable (FIG. 3E). It is a multi-stack cable (with 4 HTS tape stacks, in this example, though other designs may have a different number of channels/tape stacks). The tape stacks may be twisted along their length in a helical shape, as illustrated in FIG. 6B. Optionally, each tape stack may be surrounded by a conductive (e.g. copper) former, which may serve as a stabilizer for stabilizing tape stacks in an HTS cable. Reduced eddy-current losses may be accomplished by segmenting or partitioning the former and installing dielectric insulation between the segments. In embodiments, such an approach may result in a more than 20 times reduction of eddy-current heating compared with its non-segmented, VIPER, cable (FIG. 3F), which is another example of HTS cable 230. The VIPER cable of FIG. 3F is similar to the VIPER cable of FIG. 3E but without the insulation segmenting the former.

In some embodiments, AC losses can be reduced by using a material of higher electrical resistivity for the former. For example, steel may be used for the former instead of copper. A (confirmed by experiment) numerical model shows that partitioning a VIPER cable reduces AC losses in the former due to an oscillating external transverse magnetic field by a factor of 1.7. Replacing a copper former with steel further reduces losses by a factor of 2.7. These results are depicted in FIG. 3G.

One advantage of the VIPER and PIT VIPER arrangements is that this topology is well suited to the presence of a cooling channel in the center, as shown in FIG. 3E. This permits efficient cooling for the HTS materials by a flow of liquid cryogenic fluids.

In case of relatively small AC losses, when technical conditions permit using conduction cooling, the cooling channel may be eliminated and replaced by an extension of the segmented former (FIG. 3H). Alternatively, the channel can be left in place and either left empty or filled at room temperature by liquid or high pressure gas, which at the operating cryogenic temperature is in the liquid or solid state, providing additional thermal stability to the superconductor.

In the conduction-cooled arrangements there is no coolant removing the heat from inside the winding. Instead, the heat is removed from the body of the magnet to a thermal intercept outside the winding by conduction through high thermal conductivity elements. These may be laid along the layer-to-layer (pancake-to-pancake) insulation insulated copper wires or insulated copper strips.

In case of the sufficiency of a conduction cooled scheme other cables without a cooling channel can be used. The TSTC cable (FIG. 3I), CROCO cable (FIG. 3J) and CORC cable (not shown) are other examples of HTS cable 230 that are well suited for being used in a no-insulation arrangement. In both cases the twisted tape stack may be vacuum pressure impregnated into a round (e.g., steel) tube with solder for a better transverse thermo-electrical conduction. An advantage of these cables is high filling factor, i.e., the ratio of the area of a superconductor to the area of the winding, and consequently higher engineering current density, which can be significant in some applications. To further reduce AC losses from tape-to-tape in-stack coupling tape stacks can be reduced in size by either using narrow tape or reducing the number of tapes in a stack or both. Using advanced tapes, like shown in FIG. 3K filamentized tapes by Subra (www.subra.dk) also can significantly reduce AC losses. Another advantage of these cables is that they are formed by a twisted tape stack. Twisting the tape stack along the length of the cable permits limited bending of the cable while imposing no or small strains along the tape in the stack. Bending the cable may be done before soldering the tapes in the cable. In the process of cable bending to take the required shape this permits the tapes in the twisted stack to slip with respect to each other and significantly reduces or completely eliminates undesirable intrinsic axial strains, which otherwise can lead to a strong degradation of the superconductor and reduction of its critical current. Soldering of the tape in the cable may be done in place after bending the cable and inserting it into the groove in the structural matrix.

In some embodiments, an HTS magnet formed according to the techniques described herein may have a number of advantageous characteristics. For example, the use of a support structure may provide high structural integrity. When the HTS magnet is formed as an NI magnet, which provides a conductive path between respective turns of the HTS material, there can be a number of advantages. For example, omitting insulation may avoid problems with radiation damage. An NI magnet may have high quench resistance. Cooling of the HTS material may be provided by coolant flow in a channel of the HTS cable having contact with a high-conductivity material (e.g., copper) which in turn may be in close contact with the HTS material. Such a magnet may have reduced exposure to AC (alternating current) losses, shielding and eddy currents. The soldering quality of the HTS material may be high due to the flowing of the molten metal into the cable.

### Further Examples of HTS Cables and Molten Metal Filling

Described are processes, systems, devices and techniques for filling high-temperature superconducting (HTS) cables with a molten metal.

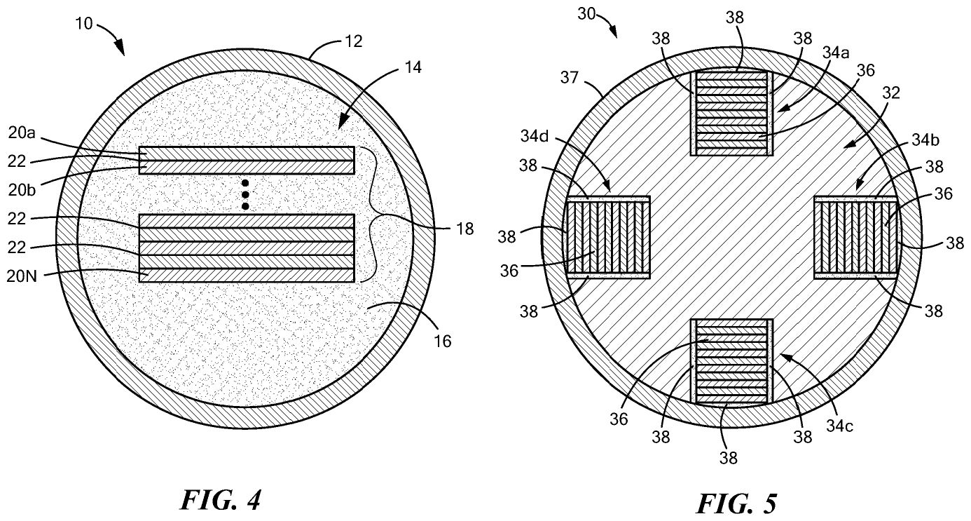

FIG. 4 shows an example of an HTS cable having a single HTS tape stack. The HTS cable includes a jacket having an HTS material disposed therein. The jacket may be in the shape of a tube. An HTS tape stack is illustrated having a plurality of tape layers of HTS material. Each layer may comprise a single HTS material or a plurality of different HTS materials.

In this example, the jacket (and thus the cable) is illustrated as having a circular cross-sectional shape. It should, of course, be appreciated that that the jacket or cable may be provided having any regular (e.g. rectangular, square, triangular) or irregular cross-sectional shape. Further, depending upon the application, different jackets/cables may not have the same cross-sectional shape. The particular cross-sectional shape of the jackets/cables may be selected to fit the needs of the particular application in which the jackets/cables will be used. In some embodiments, the processes described herein for filling the HTS cable with a molten metal may result in the molten metal being disposed around and/or contacting the surfaces of the HTS material. In some embodiments, the molten metal may fill interstitial spaces between the layers of HTS tape.

FIG. 5 shows an embodiment of an HTS cable having a plurality of HTS tape stacks disposed in respective channels of a former. In this example, the cable comprises a former having a plurality of channels, here four channels, formed or otherwise provided therein with a multi-stack HTS tape disposed in each channel. A jacket is disposed around the former. Any number of channels may be used. The number of channels may be selected to fit the needs of the particular application in which the cable will be used.

In this illustrative embodiment, each channel may have a generally square cross-sectional shape. However, the channels may have any regular (e.g. rectangular, circular, triangular) or irregular cross-sectional shape. Further, depending upon the application, each channel may not have the same cross-sectional shape, i.e., different channels may have different shapes. The particular cross-sectional shape of the channels may be selected to fit the needs of the particular application in which the cable will be used. The metal-filling process described herein may be used to fill the cable, and in particular, any channels provided in the former with a molten metal (e.g., a solder). The metal filling process described may fill around each HTS tape stack, spaces between the HTS tape layers which comprise the stack HTS tape and spaces which may exist between surfaces of the former and surfaces of the jacket.

The metal-filling process described herein may be applied to any cable comprising a jacket and no former (e.g., as illustrated in FIG. 4) and/or comprising both a jacket and a former (e.g., as illustrated in FIG. 5). Furthermore, the metal-filling process described herein may readily be used to fill tubes or channels having arbitrary or complex cross-sectional shapes as well as arbitrary or complex patterns with molten metal. Moreover, the metal-filling process described herein may be used on cables of any length.

Referring now to FIGS. 6A and 6B, a cable comprises a former having a plurality of channels provided therein. In this illustrative embodiment, the former has one channel corresponding to a cooling channel provided along a central longitudinal axis of the former. In embodiments, the former may have a plurality of cooling channels provided therein. The former has a plurality of channels, formed or otherwise provided therein with an HTS material provided therein. In the illustrative embodiment of FIG. 6A, the HTS material is shown as a multi-stack HTS tape disposed in each channel. Other configurations of HTS materials, may of course, also be used. A jacket is disposed around the former. In this illustrative embodiment (and as may be more clearly seen in FIG. 6B), the channels may have a twisted or spiral pattern along a surface of the former along a length of the former with each channel having a generally square cross-sectional shape, which means that the HTS tape(s) are twisted along the length of the HTS cable. Twisting the HTS tapes along the length of the HTS cable allows redistribution of forces in the tape when the cable is bent.

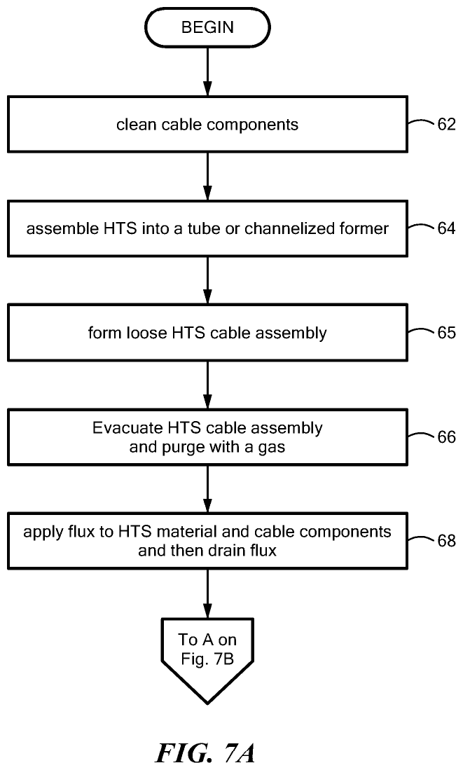

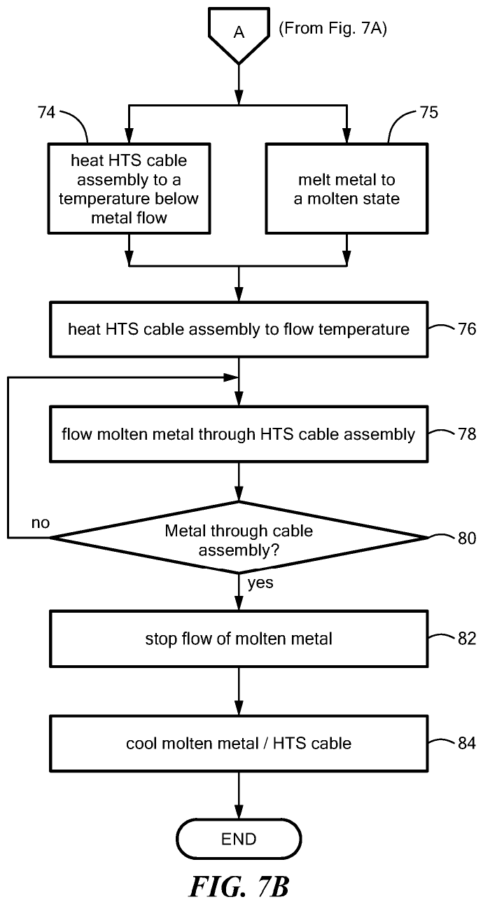

FIGS. 7A and 7B form a flow diagram made up of a sequence of processing elements which form an illustrative embodiment of a metal-filling process in accordance with the concepts described herein. It should be appreciated that, unless explicitly stated, the processing elements in the flow diagram are unordered meaning that the process elements listed in the flow diagram may be performed in any suitable order.

As shown in FIGS. 7A and 7B, an illustrative process for filling an HTS cable with solder begins by cleaning components (e.g. a tube, a former, HTS materials, jacket, fittings, etc. . . . ) which will be used in a cable undergoing the solder-filling process (62). In embodiments, the cable components may be cleaned using a process involving flushing with an acidic solution and then water rinse. Details of such a process in relation to one particular embodiment are described below.

As one non-limiting example, a reservoir comprising a mixture of water and a cleaning solution (e.g., Citronox acidic cleaner) may be coupled to the cable former and the mixture pumped from the reservoir through the cable former. Subsequently, clean water may be pumped through the cable former to rinse the cleaning solution out of the cable former. In some cases, the mixture and/or the clean water during rinsing may be heated to above room temperature (e.g., 140° F.).

Once the components are cleaned, the HTS material is disposed in a jacket or in channels of a channelized former (64). In embodiments, the HTS material may be provided as an HTS tape stack. In embodiments, the HTS tape stack may be pre-tinned to assure a good bond between tapes (e.g., a bond in which tapes are securely coupled together) in a tight stack. In one embodiment, the HTS tape stack may be pre-tinned with the metal to be used to fill the cable. In one embodiment, an HTS tape is pre-plated with PbSn solder.

A “loose HTS cable assembly” (or more simply an “HTS cable assembly”) is then formed (65). The HTS cable assembly is sometimes referred to as a “loose cable assembly” since at least the HTS material (and possibly other components) have not been structurally secured to the tube or channelized former or other structure which forms part of the HTS cable. As used herein, an “HTS cable assembly” or “loose HTS cable assembly” may refer to any vessel comprising an HTS (e.g., an HTS tape), examples of which are provided herein. For instance, one type of HTS cable assembly may be formed by disposing HTS material in a tube and optionally adding fittings, etc. . . . if needed. As another example, an HTS cable assembly may comprise a channelized former, in which HTS material is disposed in appropriate ones of the channels and optionally adding fittings, etc. . . . if needed. Other types of HTS cable assemblies may be envisioned and the techniques for filling an HTS cable assembly with a metal applied thereto.

Returning to now to FIG. 7A, the HTS cable assembly is then evacuated (e.g. via a vacuum process) and purged with an inert gas (66) and flux is applied to the HTS material and cable components which will form the HTS cable to remove any oxidation. In embodiments, a liquid flux may be applied shortly prior to soldering. This can penetrate all surfaces in a manner similar to the subsequent flow of molten-metal to be described. In embodiments, it has been found that application of liquid flux enables good wetting of solder to tape and cable. In embodiments, RMA-5 liquid flux was used, but other liquid fluxes having the same or similar characteristics may also be used.

Excess flux is drained from the assembly (68). It has been found that any remaining flux is effectively flushed by the flow of heavier molten metal solder (to be described in conjunction with 78). As such, an explicit step of draining excess flux may not be required, depending upon how much flux remains in the assembly. In embodiments having long and complex cable geometries, pressurization may effectively be used to drain excess flux.

The HTS cable assembly is heated to a temperature which is below a temperature which would cause metal (e.g., solder) to melt (74). In embodiments, a convection oven may be used to control the temperature of the cable and all of the fittings and piping during the metal fill process. This provides a degree of uniformity with minimal external control needed and, importantly, avoids any risk of HTS tape exceeding the oven setpoint and causing degradation to that portion of the cable.

Either before, after or concurrently with the heating of the cable assembly (74) the metal with which the HTS cable will be filled is melted to a liquid state (75). The metal may be melted, for example, using temperature controlled heaters in a can or crucible. Thermocouples inside and outside the can may be used to determine when melt is complete, and the temperature of the molten metal before flowing. In some embodiments, the metal may be melted inside the oven in which the cable is located but in other embodiments, the metal may be melted separately (i.e., outside the oven). The HTS cable assembly is then heated to a temperature at which the metal will flow (76).

One aspect of the metal fill process found to be significant has been obtaining a desirable time-temperature profile. Temperatures should be high enough for the metal to be fluid with low viscosity, yet result in low enough exposure to avoid thermal degradation, and degradation due to chemical effects of the metal on the HTS material (e.g., a REBCO tape stack).

In one embodiment for solder filling of an HTS cable comprising an HTS tape stack comprising layers of REBCO tape and using PbSn solder, two steps may be used. First, the oven may be set to a temperature which warms the HTS cable assembly, but which does not degrade the HTS tape. In embodiments, the oven may be set to a temperature below the melt point of the solder on the HTS tapes (e.g. of 185° C. for PbSn solders) to thereby greatly reduce, and ideally to avoid, degradation of the HTS tape stack and the temperature of the entire cable (or more properly the cable assembly) is allowed to equilibrate. The cable assembly is held at this temperature until a solder supply is fully melted and equilibrated to the process temperature of 200 C. Second, the oven temperature may then be set to a temperature which achieves a desired flow temperature. In embodiments utilizing PbSn solder, the oven temperature may be set to a temperature of about 205° C. and a waiting period may occur until all points on the cable and solder station tubing have achieved a desired flow temperature (e.g., a flow temperature of 200° C. in the case of PbSn solder) and temperature monitoring is performed to ensure that no point exceeds a temperature of 202° C. (so as to reduce, and ideally avoid, any degradation of the HTS tape stack. Once these conditions are met, the solder flow step 78 may begin (and preferably promptly begins so as to reduce -and ideally minimize- thermal exposure of the HTS tape stack).

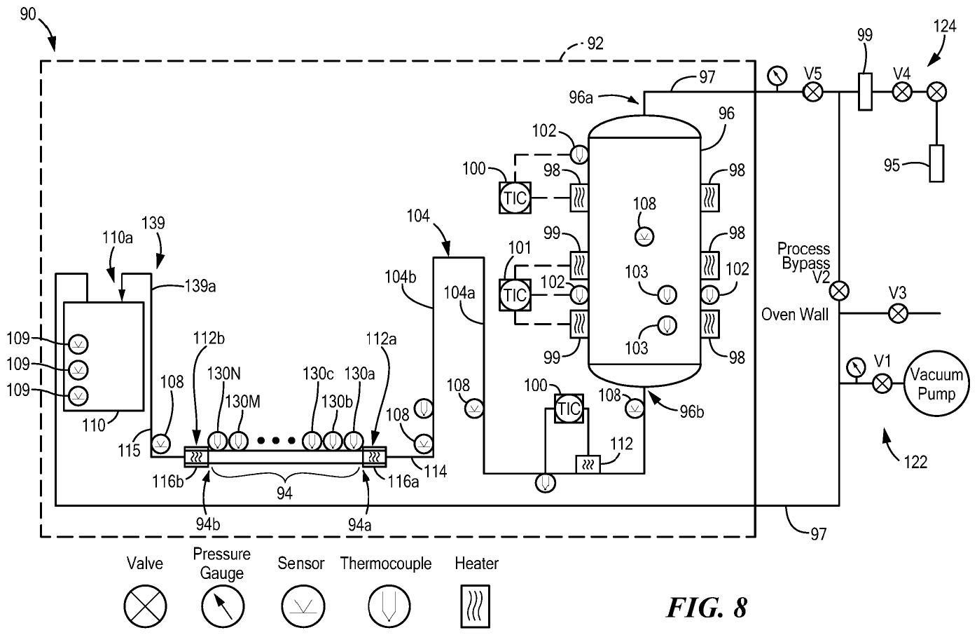

Application and monitoring of a plurality of temperature monitoring devices (e.g. thermocouples) at multiple points in the processing station (an example of which is described below in conjunction with FIG. 8) and on the cables may be important to the process, since degradation of REBCO increases exponentially with temperature above 200° C. The locations of the temperature monitoring devices are selected for each cable geometry. Considerations will include the size and expected thermal uniformity of the cable, and the input which will be needed to guide the planned cooling process. Temperatures may be adjusted for different solders or type of HTS tape. Such an optimized time-temperature profile for solder-filling of HTS cables is one significant aspect in the success of the described technique.

Processing elements 78, 80 implement a loop to ensure that molten metal flows through the entire cable assembly. In embodiments, the flow of molten metal through the entire cable assembly may be achieved at least partially via gravity (e.g., at atmospheric pressure), via displacement pump, or using a vacuum-pressure technique. One example of a vacuum-pressure technique will be described below in conjunction with FIG. 8.

In decision block 80, once a decision has been made that molten metal has flowed through the portion of the cable assembly in which the HTS material is disposed, then the flow of molten metal is stopped (82) and the molten metal and HTS cable assembly are cooled (84) and after cooling is complete a solder-filled HTS cable is resultant.

In the illustrative method shown in FIGS. 7A and 7B, it will be appreciated that the method may be carried out without it always being necessary to perform all of the steps shown in the flowchart and in the specific order presented. Furthermore, in at least some cases some steps of the method might be performed simultaneously. As one non-limiting example, in some cases the application of flux in (68) may be performed prior to the evacuation of the HTS cable assembly in (66). As another non-limiting example, in some cases the HTS cable assembly (74) and melting of the metal (75) may be performed concurrently or either step may be started or even completed prior to the other. In some cases, steps of the illustrative method (and/or portions of the steps) shown in FIGS. 7A and 7B may be omitted entirely. For instance, in some embodiments, step (68) in which flux is applied to the HTS material and drained may be omitted. In some embodiments, the purging aspect of step (66) may be omitted, although the evacuation aspect of step (66) may be performed.

Referring now to FIG. 8, a processing station 90 which may be used to carry out a metal-filling process which may be the same as or similar to the process described in conjunction with FIGS. 7A, 7B includes an oven sized to accommodate an HTS cable assembly 94, a resultant HTS cable (not shown in FIG. 8), and optionally a container 96 (e.g. a crucible) for holding a molten metal and associated entry and exit tubing generally denoted 97. A gas source 95 is coupled to an input 96a of container 96 through one or more valves V4, V5 and a flow controller 99 which limits the gas flow rate and thus the initial velocity of solder flow

The container 96 (also sometimes referred to herein as a “can”) is disposed to hold an amount of metal (e.g. solder) sufficient to fill the cable assembly 94 and may be located inside or outside oven 92. In embodiments, the container may be provided having a cylindrical shape of sufficient length and diameter to hold a metal (e.g. solder). In embodiments, the container may comprise a cylindrical stainless steel (SS) tube, ˜3.5″ outer diameter, configured to hold up to 30 lbs of a metal (e.g. up to 30 lbs of solder bars). Other shapes may, of course, also be used. In general, however, container 90 should be sized to hold an amount of molten metal at least sufficient to fill an HTS cable of a known size according to the concepts and processes described herein, and ideally some additional metal to flow through the cable, fill all voids and flush any impurities. After reading the description provided herein, one of ordinary skill in the art will appreciate how to select the appropriate amount of metal and thus the container shape and size (e.g. volume) for a specific application.

A plurality of heaters 98 are disposed about container 96 (e.g. on an internal or external surface of container 96) and configured so as to heat the container in a desired fashion. The heaters may be coupled to one or more controllers 100 which control the heaters. In one embodiment three 650 W, 120 VAC heaters are thermally coupled to the container and controlled with one or more proportional-integral-derivative (PID) processors (not shown in FIG. 8). In embodiments, the controllers may be provided as a Solo SL4848-VV series controllers from Automation Direct. In this embodiment, the output of the controllers 100 is a voltage pulse that operates a relay which then gates duty cycle controlled 120VAC power to the heaters. Other means for heating the container 90 may (or other means for melting the metal inside the container), of course, also be used.

A plurality of thermocouples 102 outside container 96, and two thermocouples 103 at different levels inside container 96 (e.g. disposed within tubing such as stainless steel tubing having a known thickness selected to not interfere with the operating of the thermocouples), may be used to control the melt process and establish when melt of a metal inside the container is complete. A plurality of heaters 99 proximate the outlet of the container 90 (with two heaters 99 being shown in FIG. 8) are controlled cooperatively, using a single external thermocouple (TC) 101 and an upper heater 98 (650W max) is controlled separately from heaters 99. Details of thermocouples and other instrumentation can vary depending on the size and geometry of the cable being processed (i.e. the cable to be filled).

After reading the description provided herein, one of ordinary skill in the art will appreciate how to select the appropriate number, size (in watts) and placement (i.e. physical location) of heaters as well as the number, characteristics and placement (i.e. physical location) of thermocouples to suit the needs for a specific application.

A siphon 104 has a first end coupled to an output 96b of the container 96. The siphon is provided having a height greater than that the height of molten metal in the container so that flow cannot occur without pressurization. In embodiments, the siphon 104 may comprise tubing having a 0.5″ inner diameter.

A plurality of contact sensors 108 are disposed at various points in processing station 90 to monitor both the melting and the flow of metal. In embodiments, the contact sensors may be provided as commercially available, single-conductor vacuum feedthrough sensors. In embodiments, the contact sensors have a pin. In embodiments, the pin may be part of a coaxial structure with a center pin, a ceramic insulator, and a stainless-steel outer housing. In one embodiment, the feedthroughs are brazed or otherwise secured to fitting (e.g. threaded end caps) that can be connected to mating fixtures on the various apparatus (e.g. siphon, connecting tubing and dump tank) which are part of the processing station. Some sensors 108 may be disposed near the expected level of liquid solder in the container, and sensors 109 may be disposed (either internally or externally) in or on a dump tank 110 at different levels or heights. In this example embodiment of FIG. 8, a set of three sensors are disposed at different heights in the dump tank. Such sensor placements may be helpful in monitoring the metal-fill process and stopping at the desired quantity of solder or other metal.

In one embodiment, to detect the presence of solder, the center pin of the sensor is connected to a DC power supply (e.g. 5 to 24 volts DC) through a light emitting diode (LED) lamp and a current limiting resistor. The tanks and pipes are connected to a reference potential (e.g. electrical ground or 0 VDC) and the voltage on the center pin is recorded.

In this embodiment, in the absence of solder, there is no connection between center pin of the sensor and reference potential (e.g. there is no connection between center pin of the sensor and ground). The LED is off, and the recorded voltage is HIGH (e.g. a voltage level corresponding to a logic HIGH value). In the presence of solder, the center pin is connected to ground. The LED is energized, and the recorded voltage is LOW (e.g. a voltage level corresponding to a logic LOW value). Such electronics provides both a visual indication of solder flow highly useful for prompt manual control of the process and an electronic record and inlet which is useful for post-process interpretation and could be used for process automation (e.g. using a programmable logic controller).

In embodiments in which the HTS cable assembly 94 comprises a former and a jacket disposed about the former the jacket extends beyond the ends of the HTS cable assembly 94 as denoted by reference numerals 112a, 112b in FIG. 8. Extensions 112a, 112b enable a smooth transition of metal flow (e.g. solder flow) from the inlet tubing 114 to the cable assembly (e.g. former and jacket), and at the outlet tubing 115 which leads to the dump tank 110. If it is desired or necessary to bend extensions, the extensions preferably are provided having smooth bends.

Heaters 116a, 116b are disposed proximate to or otherwise coupled to extensions 112a, 112b and the heat extensions so as to maintain liquid solder in these extensions until the solder in the cable assembly 94 has solidified. In embodiments, a heater may be placed on either side of each bend in the inlet and outlet tubing 114, 115 or also on each end of the cable assembly. As described below, heaters play a role in avoiding the occurrence of voids which may otherwise occur as a result of cooling of the molten metal in the cable assembly.

The tube 115 at the entrance 110a of dump tank 110 is provided having a second ‘u-bend’ 140. This prevents the initial solder and flux which has flowed through the cable to be filled and into the dump tank from backflowing into the cable assembly.

The dump tank holds excess molten metal after flowing through the cable assembly. As noted, contact sensors 109 at various heights indicate how much molten metal has reached the dump tank. A variable flow valve (99) regulates the rate of gas flow (e.g. inert gas flow) and pressure rise. In embodiments, an inert gas such as Argon may be used, but another inert gas may be used. In embodiments, the dump tank may comprise a stainless steel tube having a diameter of about 4 inches with an entrance from the top and may be sized to hold up to about 10 lbs of excess molten metal (e.g. excess solder).

Those of ordinary skill in the art will understand how to size the dump tank to meet the needs of a particular application.

The container and dump tank are coupled to (i.e. in fluid communication with) a vacuum system 122 and gas system 124 which allows them to be either evacuated (to typically 250 mTorr) or pressurized with an inert gas such as Argon, for example. A variable flow valve 99 may be used to regulate the rate of gas flow and pressure rise. Valve V4 is an open/closed valve and valve 99 is a flow regulator/valve.

Thermocouples may be disposed at various multiple points in the system (e.g. on the can, pipe, oven) and may be monitored in real time (e.g. via a monitor), including thermocouples 130a along the cable to be filled 94. In embodiments, for a cable assembly having a length of about 10 meters up to eighteen (18) thermocouples may be monitored in real time via two sixteen (16) channel Agilent 34972A scanners at typically a 1 sec rate. Such a monitor may also store and displays the contact sensor state—converted to a DC voltage as described above—and pressure gauge analog outputs. Spacing of the thermocouples will depend upon cable length, geometry, expected thermal uniformity and planned cooling method.

The processing station also includes a vacuum and pressurization system 131 comprising a vacuum pump 133 and a plurality of valves 134 and tubing 136 which allows the inlet section of the cable assembly and the solder can, and the outlet section of the cable assembly 94 and solder dump 110, to be independently evacuated, pumped or pressurized. Thus, it should be appreciated that cable assembly 94 is coupled to the associated tubing, fixtures, sensors, heaters, thermocouples in a manner which forms a closed system thereby enabling the various components (including the cable assembly) to be evacuated and/or pressurized.

Before filling the HTS cable with metal, a bypass valve V2 is kept open to equalize pressure at each end of the cable assembly 94. This and siphon section 104 between the container 104 and cable assembly 94 prevent premature flow of solder before all components are at the target temperature. Once both the metal in the container and the cable are at their respective target temperatures, metal flow is started. In an embodiment, metal flow may be started by setting a gas pressure on gas source 95 to a target pressure.

To flow the metal, the bypass valve V2 is closed enabling differential pressure between cable assembly ends 94a, 94b. At this point the exit 96b of container 96 is blocked by molten metal and pressure from gas source 95 forces the metal from the container 96 through tubing and siphon 104 into the cable assembly 94 via extension 112a.

In embodiments, a pressurized inert gas from source 95 is applied to the container (e.g. by opening valves V4, V5 thereby pushing the molten metal down and over the inlet siphon 104 to the cable assembly. Molten metal flow continues through the cable assembly, penetrating all the vacuum gaps including any spaces between and around the HTS material. Since the molten metal is heavier than the flux, the molten metal pushes any remaining lighter flux ahead of it. In this manner, a vacuum-pressure impregnation (VPI) process to fill cable assemblies (e.g. comprising tubes or jacketed formers) containing high temperature superconducting material with molten metal is provided.

A second inverted tube (‘siphon’) 139 is used between the cable assembly outlet 94b and the dump tank inlet 110a, with similar height to the inlet siphon 104. This prevents molten metal from flowing out under gravity. Molten metal remaining in each vertical section 104a, 104b, 139a provides pressure on metal-filled cable assembly after flow.

In embodiments, contact sensors 108, 109 may be used at multiple points in the system to monitor and help control molten metal flow. For example, contact sensors may be placed internal and/or external to the can; at the outlet of the container; in the inlet siphon; at the cable inlet and/or outlet; and at multiple heights in the dump tank. In embodiments, the contact sensor comprises a pin and the pin of the sensor must be internal to the can and contact solder. In embodiments, one or more sensors may be disposed on a wall of the can with a fitting that penetrates the wall through which a pin of the sensor is disposed such that when solder (or another molten metal) reaches the level of the sensor pin the pin is capable of contacting the solder). In embodiments, one or more sensors may be disposed in a tube which is internal tube to the can. Contact sensors at the cable outlet and inside the dump may be used to monitor the flow of molten metal. The use of sensors inside the dump tank, at multiple levels, allows one to set a predetermined quantify of molten metal flowing through the cable to optimize filling, and flushing of the flux.

In an embodiment, typically 5-10 lbs of molten metal reside in the exit tubing and dump tank which is sufficient for a cable having a length of about three meters. Once the target level is reached, the bypass valve V2 is opened, which again equalizes pressure between the first and second ends of the cable assembly and thereby stops flow, ensuring that the inlet tubing of the cable assembly is not emptied.

In embodiments, the contact sensors 108, 109 may be provided as commercially-available, single-conductor vacuum feedthrough having a coaxial structure with a center pin, a ceramic insulator, and a stainless steel outer housing. For this application, the feedthroughs may be brazed to threaded end caps that can be coupled to mating fixtures on the equipment.

In embodiments, all tanks, pipe, and fixtures may comprise or consist of conductive copper or stainless steel, and may be disposed within the oven to ensure uniform temperature. In embodiments, vacuum levels of typically a few hundred mTorr are achieved before fluxing and typically 1-few Torr after fluxing. After reading the disclosure provided herein, those of ordinary skill in the art will appreciate how to select a vacuum level for a particular application. The vacuum ensures an oxygen free environment before heating and ensures good impregnation of metal (e.g. solder) to all parts of the cable, around and between tapes, and even in gaps between surfaces of the former and jacket.

Following the solder flow, one or more air movers (e.g. blowers) may be used to direct air preferentially at selected zones on the cable so as to control the cooling profile of the cable. The particular technique to cool a metal-filled cable is selected in accordance with the geometry of the cable. For an HTS cable bent in a generally circular or loop shape, a movable baffle may be utilized to localize the cooling to specific parts of the loop.

### Example Solder Material and Tape/Cable Structures and Methods of Forming Same

Some aspects of the concepts described herein relate to solders and other liquid metals and, in particular, to solders or other liquid metals used for superconductive materials or other applications. Certain aspects, for example, are generally related to structures, such as wires or tapes, comprising a superconductive material and portions containing copper or silver. The structure may be in contact with a metal, such as a solder, which is in contact with the copper or silver portions; for example, the metal may be used to form the structure into a cable or other articles. Although some types of solder may “extract” or remove copper or silver from the structure when in contact, e.g., due to diffusion or dissolution of metal into the solder, the metals described herein that are used with the structure may exhibit little or no extraction from the structure. Thus, such metals may be helpful in preventing degradation of the structure. Other aspects include methods of making or using such solders and other liquid metals, kits involving the same, or the like.

Certain aspects relate to solders or other metals that are added to superconductive materials, e.g., to form cables or other articles. For instance, the superconductive material may be present within wires or other structures, and a plurality of such wires and/or structures can be formed into a cable. The wires may be held or otherwise secured in place within the cable using solder or other metals, e.g., which may be present within void or interstitial spaces created between the wires.

Examples of superconductive materials that may be used include cuprate superconductors, for example, rare-earth barium copper oxides (REBCO) such as yttrium barium copper oxide (YBCO). Such superconductors typically contain oxygen atoms within their atomic structures, which help such materials to exhibit superconductivity when exposed to suitably low temperatures. However, in some cases, some of the oxygen atoms can migrate away, which limits or prevents such materials from becoming superconductive.

To prevent this from occurring, in some cases, the wire or other structure may include a portion or layer of material surrounding the superconductive materials that prevents or inhibits oxygen from migrating through. One example of such a material is silver. Thus, in some embodiments, a superconductive material may be partially or completely surrounded by a layer comprising silver, which may prevent oxygen migration away from the superconductive material.

However, solders in contact with silver or other materials may be able to remove or extract some of the silver (e.g., as silver ions) out of the silver layer, e.g., due to diffusion or dissolution of silver into the solder. This process may be exacerbated by higher temperatures, which may increase the speed at which diffusion or dissolution occurs. Thus, for example, the solder may be applied in liquid form, at relatively high temperatures, and may remain at such temperatures for relatively long periods of time (e.g., hours) during the manufacturing process of the cable or other article. During that time, a surprisingly large amount of silver may be extracted by the solder, resulting in a significantly degraded silver layer and poor performance of the resulting article.

One method to reduce this effect is to add an interposing layer of another material to the wire or other structure, such as a copper layer around the silver layer. Copper may also provide other benefits, e.g., electrical or thermal stabilization. For instance, if the superconductive material loses its superconductivity properties, the copper may help to absorb heat and/or bypass current around the superconductive material. However, some solders can also extract copper from a copper layer. Accordingly, a solder in contact with a copper layer may initially extract copper from the copper layer, and in such cases, so much copper that the solder also comes into contact with the silver layer, resulting in degradation as discussed above. In some cases, additional degradation may occur by intermetallic formation with the outer copper layer, e.g., scalloped intermetallic formation. The intermetallic formation may reduce the n value of the superconductor (a measure of performance), and/or allow delamination of the copper and/or silver layers. Thus, various metal layers around the structure may become degraded.

Thus, certain embodiments as discussed herein relate to solders and other metals that are not able to extract substantial amounts of copper and/or silver from a wire or other structure. In some cases, the solder or other metal may contain some amounts of copper and/or silver, e.g., such that there is reduced or no ability of the solder or other metal to contain further amounts of copper and/or silver (e.g., which would be removed from the wire). For instance, the solder may contain a saturation concentration of copper and/or silver, and/or a large concentration relative to the saturation concentration (e.g., at least 50%, at least 75%, at least 90%, at least 95%, etc. of this concentration).

A wide variety of solders and other metals may be used, including lead-tin (PbSn) or indium-tin (InSn) solders. Other solders are described in detail below. Such solders may contain varying amount of copper and/or silver.

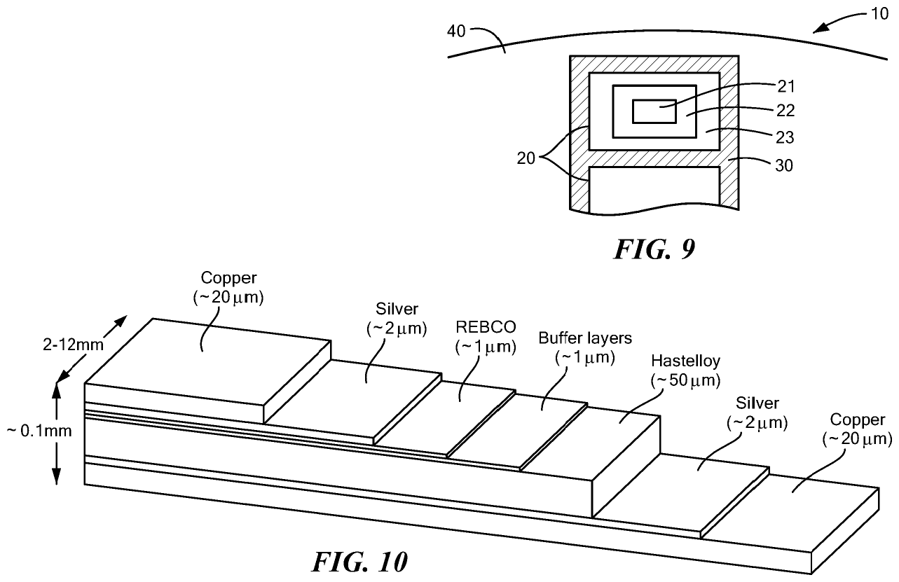

One non-limiting example of such a structure can be seen in FIG. 9. In this figure, an article 10, such as a cable can contain one or more structures 20. Structures 20 may be wires or other structures such as is described herein, and if more than one structure is present within article 10, they may be the same or different. Only one such structure is provided in this figure in detail for the sake of clarity.

Such articles may be assembled, in part, by applying a liquid metal around at least a portion of the structures, e.g., into void or interstitial spaces around the structures, and allowing the liquid metal to cool to form a solid 30 within the article. As mentioned, the liquid metal may be introduced using a variety of techniques. The metal may also be introduced or used in other applications in other embodiments, not just VPI techniques. Other components 40 may also be present within the article, e.g., to define channels, slots, etc. containing structures 20, although metal 30 may be used within the article to facilitate thermal and/or electrical contact.

Structure 20, in this figure, includes a first region 21, a second region 22 at least partially surrounding the first region, and a third region 23 at least partially surrounding the second region. Although only three such regions are shown here for the sake of clarity, fewer or more regions may also be present in other embodiments, and may be position between any two of these regions, or in other suitable configurations. In addition, while these are shown here as having rectangular cross-sections, other shapes (e.g., flat or layered such as is shown in FIG. 1, circular, etc.) are also possible in other embodiments. Non-limiting examples include regular (e.g. rectangular, circular, triangular) or irregular cross-sectional shapes.

In this example, for instance, first region 21 may contain a superconductive material, such as REBCO or another cuprate superconductor. Second region 22 may comprise silver. This region may be used to prevent or inhibit the migration of oxygen out of first region 21. Third region 23 may comprise copper. This may be used to at least partially prevent metal 30 from coming into contact with second region 22. As previously discussed, in some cases, metal 30 may contain copper, e.g., in amounts that are able to prevent or inhibit the migration of copper out of third region 33. For example, metal 30 may comprise a solder such as a PbSn solder, with some copper present. One non-limiting example of such a solder is Sn₆₂Pb₃₆Cu₂ (i.e., 62% Sn, 36% Pb, 2% Cu; it will be understood that the subscripts in such formulae represent weight percentages rather than stoichiometric ratios).

Other embodiments are also possible, in addition to the ones discussed above and with reference to FIG. 9. Accordingly, more generally, various aspects of the described concepts relate to various systems and methods for solders or other metals used for superconductive materials or other applications.

For example, certain aspects are generally relate to cables or other articles that include one or more structures, including wires such as those discussed herein. Non-limiting examples of other articles include superconducting joints or magnets, such as cable structures, pancake “wound” structures, or the like. Any number of structures may be present within the article, for example, 1, 2, 3, 4, 5, 6, 7, 8, or more wires or other structures. If more than one is present, the structures may be the same or different. Examples of such structures are provided in more detail herein.

As mentioned, such articles may be assembled, in part, by applying a solder or other metal in liquid form around at least a portion of the structures, for example, into spaces around the structures, and allowing the solder or other metal to solidify to form a solid, e.g., via cooling. The solder or other metal may be allowed to fill all or only a portion of the spaces around the structures. For example, at least 50%, at least 60%, at least 70%, at least 80%, at least 90%, at least 95%, or substantially all of the volume of the article may be filled, e.g., with a solder or other metal, and/or with structures, wires, or other components.

In some cases, the solder or other metal may form a substantial part of the article. For example, at least 5%, at least 10%, at least 15%, at least 20%, at least 25%, at least 30% at least 35%, at least 40%, at least 45%, at least 50%, etc. of the volume of the article may be the solder or other metal. In some cases, however, no more than 50%, no more than 45%, no more than 40%, no more than 35%, no more than 30%, no more than 25%, no more than 20%, no more than 15%, no more than 10%, or no more than 5% of the volume of the article may be the solder or other metal. Combinations of these ranges are also possible in various embodiments; for example, the solder or other metal may form between 5% and 10% of the volume of a cable or other article as discussed herein.

Any of a wide variety of solders may be used. The solder may be a metal with a relatively low melting point, e.g., less than about 250° C., or less than 225° C. In another embodiment, the melting point is less than about 200° C. In some cases, the melting point of the solder is at least 100° C., at least 150° C., at least 160° C., at least 170° C., or at least 180° C. In addition, in certain embodiments, the melting point may fall between any of these ranges. For instance, the melting point may be between 180° C. and 200° C.

One, two, three, or more metal elements may be present within the solder or other metal. Non-limiting examples of metal elements include Ag, Pb, Sn, In, Bi, Hg, Zn, or the like. In addition, in some cases, noble metals such as those discussed herein may be present.

Any of these elements may be present in any suitable combination. For example, an element may be present in the solder or other metal at a concentration of at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, etc. and/or no more than 75 wt %, no more than 70 wt %, no more than 65 wt %, no more than 60 wt %, no more than 55 wt %, no more than 50 wt %, no more than 45 wt %, no more than 40 wt %, no more than 35 wt %, no more than 30 wt %, or no more than 25 wt %. Other ranges of percentages are also possible in other embodiments for each of the elements.

As a non-limiting example, a solder or other metal may comprise at least 10 wt %, at least 20 wt %, at least 30 wt %, at least 40 wt %, at least 50 wt %, at least 60 wt %, at least 70 wt %, etc. (or other percentages as described above) of Sn, e.g., in metals such as PbSn or InSn. As another example, a solder or other metal may comprise at least 10 wt %, at least 20 wt %, at least 30 wt %, at least 40 wt %, at least 50 wt %, at least 60 wt %, at least 70 wt %, etc. (or other percentages as described above) of Pb. As still another example, a solder or other metal may comprise at least 10 wt %, at least 20 wt %, at least 30 wt %, at least 40 wt %, at least 50 wt %, at least 60 wt %, at least 70 wt %, etc. (or other percentages as described above) of In.

In some cases, one or two elements may form the bulk of the solder or other metal. For example, at least 50 wt %, at least 55 wt %, at least 60 wt %, at least 65 wt %, at least 70 wt %, at least 75 wt %, at least 80 wt %, at least 85 wt %, at least 90 wt %, or at least 95 wt % of the solder or other metal may be formed by two or three metal elements. As a non-limiting example, a solder may be formed from Pb and Sn, and these two elements may together form at least 50 wt %, at least 55 wt %, etc. of the composition of the solder.

Non-limiting examples of tin-lead solders include Sn₆₀Pb₄₀, Sn₆₃Pb₃₇, or various tin-lead solders containing Ag and/or Cu, such as SnPbCu, SnPbAg, or SnPbCuAg (each with varying compositions, such as Sn₆₁Pb₃₅Ag₂Cu₂ and others as discussed herein) and the like. In addition to tin-lead (SnPb), other non-limiting examples of suitable solders include tin-indium (SnIn) solders. As noted, it will be understood that the subscripts in such formulae represent weight percentages, rather than stoichiometric ratios.

As mentioned, according to certain aspects, such solders or other metals may contain noble metals such as copper (Cu) and/or silver (Ag). Other examples of noble metals include ruthenium (Ru), rhodium (rh), palladium (pd), osmium (Os), iridium (Ir), platinum (Pt), and gold (Au). One, two, three, or more noble metals may be present, in various embodiments.

A noble metal, such as copper or silver, may be present in any suitable amount or concentration. For instance, a noble metal may be present in the solder or other metal at least 0.01 wt %, at least 0.02 wt %, at least 0.3 wt % at least 0.05 wt %, at least 0.07 wt %, at least 0.1 wt %, at least 0.2 wt %, at least 0.3 wt %, at least 0.5 wt %, at least 0.7 wt %, at least 1 wt %, at least 1.1 wt %, at least 1.2 wt %, at least 1.3 wt %, at least 1.5 wt %, at least 1.7 wt %, at least 2 wt %, at least 2.5 wt %, at least 3 wt %, at least 4 wt %, at least 5 wt %, at least 7 wt %, at least 10 wt %, etc.

In one set of embodiments, the noble metal is present within the solder or other metal at or near its saturation concentration (although in some cases, this may be exceeded, e.g., by creating supersaturated solutions, alloys, or other techniques). Thus, as a non-limiting example, Cu may be present at or near its saturation concentration. In addition, it should be understood that the saturation concentration may depend on a variety of factors; for example, the saturation concentration may change as a function of temperature. Thus, as a non-limiting example, the saturation concentration may increase or decrease at higher temperatures for some noble metals.

As an example, without wishing to be bound by any theory, it is believed that Cu has a saturation concentration in 65/35 Sn—Pb solder of about 0.1 wt % at approximately 200° C. When this solder is exposed to a source of copper (e.g., as discussed herein), the solder may dissolve or extract sufficient copper to form a Sn—Pb solder with Cu at its saturation concentration. As another non-limiting example, Ag has a saturation concentration of about 2 wt % in a 63/37 Sn—Pb solder at approximately 200° C.; when this solder is exposed to a source of silver (e.g., as discussed herein), the solder may remove or extract sufficient silver to form Sn₆₂Pb₃₆Ag₂ (62% Sn, 36% Pb, 2% Ag), or other Sn/Pb solder containing Ag at its saturation concentration.

Other non-limiting examples include Sn₅₉Pb₃₉Cu₂, Sn₅₉Pb₃₉Ag₂, Sn₅₈Pb₃₈Cu₂Ag₂, Sn_{96.5}Ag₃Cu_{0.5}, or the like. Solders such as these, and/or solders with different ratios of Sn and/or Pb (and/or other elements) can often be obtained commercially, and/or produced by passing a solder or other metal over a noble metal source (e.g., Cu, Ag, etc.), for instance, in a liquid state, in order to produce compositions comprising the noble metal.

In addition, it should be understood that the noble metal need not be present within the solder or other metal at its saturation concentration in other embodiments. For example, the solder or other metal may contain a noble metal, but at a concentration lower (or higher) than its saturation concentration. For instance, in certain embodiments, the noble metal may be present within the solder or other metal at a concentration of at least 50%, at least 55%, at least 60%, at least 65%, at least 70%, at least 75%, at least 80%, at least 85%, at least 90%, or at least 95% of its saturation concentration.

In some (but not all) embodiments, the solder or other metal may comprise or consist essentially of any combination of the elements described herein. For instance, a solder or other metal may consist essentially of Pb, Sn, and Cu; Pb, Sn, and Ag; Pb, Sn, Ag, and Cu; In, Sn, and Cu; In, Sn, and Ag; In, Sn, Ag, and Cu, or the like. It will be understood that absolute purity is often nearly unobtainable as a practical matter. However, in certain embodiments, if other elements are present, they may be present in quantities of less than 5 wt %, less than 1 wt %, less than 0.1 wt %, less than 0.01 wt %, or in quantities too small to substantially alter the melting point of the solder or other metal.

In certain aspects, as mentioned, the solder or other metal may be disposed within a cable or other article. For example, the article may be a superconducting article, i.e., an article that exhibits superconductive properties when cooled to a sufficiently low temperature.

In some cases, the article may be formed as cables or the like. For instance, in some cases, a plurality of wires or other structures are contained within a cable, e.g., in a twisted or an untwisted configuration, and the wires or other structures may have substantially the same or different structures. The solder or other metal may be present between some or all of these. In some cases, the cable may be bent, wound, molded, formed or otherwise made into a desired shape (e.g. the final shape of a magnet, a current lead or other structure) and prior to or contemporaneously with adding solder or other metal to the cable. In some embodiments, the cable may be provided as a tape-in-conduit cable.

The cable or other article may have any suitable length. For example, the length may be at least 1 m, at least 3 m, at least 10 m, at least 11 m, at least 25 m, at least 50 m, at least 75 m, at least 100 m, or more in some cases.

As described above, the HTS cable may be first placed into the groove of the support structure, then filled with molten metal (e.g., solder), which is then cooled to freeze the HTS cable in place within the groove of the support structure.

The cable may in some cases, be coiled, e.g., such that it can produce a relatively large magnetic field when suitable current flows through the cable. For instance, if the cable is cooled such that at least some of the wires or other structures becomes superconductive, then the coil may be able to produce a magnetic field of at least 0.01 T, at least 0.1 T, at least 0.3 T, at least 0.5 T, at least 1 T, at least 3 T, at least 5 T, at least 10 T, etc. For example, the cable may be used in a field magnet (e.g., a toroidal field magnet). In some cases, such cables may be used in fusion applications such as, for example, in an affordable, robust, and compact (ARC) nuclear fusion reactor, in MRI applications, or the like. In one embodiment, the coil is a NINT (non-insulating non-twisted) coil.

However, it should be understood that cables such as those described herein (including solders and/or liquid metals, e.g., as discussed herein) may be used in a variety of other applications as well, not just fusion applications. Non-limiting examples of such applications include, but are not limited to, nuclear magnetic resonance, magnetic resonance imaging, magnetic materials separation, accelerator/HEP magnets, disposable mixing systems, generators and motors, fault current limiters, RF filtering, SQUID (superconducting quantum interference device) circuits, transmission lines, magnetic energy storage, transformers, and current leads for low temperature superconducting cables.

A variety of methods may be used to cool the article to cause it to become superconductive. For instance, the article may be cooled by exposure to liquid nitrogen (having a boiling point of 77 K), liquid neon (having a boiling point of 25 K), liquid hydrogen (having a boiling point of 20 K), or liquid helium (having a boiling point of 4 K). Other cooling techniques can also be used in other embodiments to cause the article to become superconductive. Thus, during use of the cable or other article, it may be at least partially exposed to a cryogenic fluid (e.g., liquid nitrogen, liquid hydrogen, liquid helium, etc.), and/or low temperatures (e.g., temperatures of less than 180 K, less than 140 K, less than 100 K, less than 77 K, less than 50 K, less than 20 K, less than 10 K, less than 4 K, less than 2 K, etc. As additional examples, the article may be cooled by exposure to gaseous hydrogen, gaseous or supercritical helium (for example, at cryogenic temperatures, such as those described herein), conduction cooling using a cryocooler, or the like.

In some aspects, the cable or other article comprises a superconducting material. As discussed, the superconducting material may exhibit superconductivity when cooled to a sufficiently low temperature.

A variety of superconducting materials may be used. For example, the superconducting material may be a low-temperature superconducting material (which exhibits superconductivity at temperatures below about 30 K at self-field or zero external field) or a high-temperature superconducting material (which exhibits superconductivity at temperatures above about 30 K at self-field or zero external field). For example, high-temperature superconducting materials may exhibit superconductivity when cooled using liquid nitrogen or liquid hydrogen. In some cases, the high-temperature superconducting material may exhibit superconductivity at temperatures less than 140 K, less than 77 K, or less than 20 K.

Non-limiting examples of high-temperature superconducting materials include cuprate superconductors. An example of a cuprate superconductor is a rare-earth barium copper oxide (REBCO) materials. Specific non-limiting examples include yttrium barium copper oxide (YBCO), or bismuth strontium calcium copper oxide (BSCCO). Other examples include, but are not limited to, MgB₂, lanthanum barium copper oxide (LBCO), thallium barium calcium copper oxide (TBCCO), mercury barium calcium copper oxide (HBCCO), or the like. As mentioned, such superconductors typically contain oxygen atoms within their atomic structures. However, some of the oxygen atoms can migrate away, which may limit or prevent such materials from becoming superconductive.

Thus, in some cases, the superconducting material may be contained within a first region within the cable or other article, and partially or completely surrounded with a second region. Thus, the second region may substantially separate the first region from the third region or components (such as solder or other metals) outside of the wire, tape, or other structures. The second region may be partially or completely impermeable or impervious to oxygen, e.g., to prevent oxygen from migrating away from the superconducting material.

As an example, in one set of embodiments, the second region may comprise silver. In one embodiment, the second region consists essentially of silver. In certain cases, at least 50%, at least 75%, at least 90%, at least 95%, at least 99%, or substantially all of the second region may comprise silver.

The second region may positioned directly adjacent to the first region, or there may be one or more intervening regions present between the first region and the second region. In addition, the second region may have any suitable thickness. For example, the second region may have an average cross-sectional thickness that is less than 10 micrometers, less than 8 micrometers, less than 7 micrometers, less than 6 micrometers, less than 5 micrometers, less than 4 micrometers, less than 3 micrometers, less than 2 micrometers, less than 1 micrometers, etc. In some cases, the second region may have substantially uniform thickness, although in other cases, the second region may not have substantially uniform thickness.

In addition, in certain embodiments, the second region may be partially or completely surrounded with a third region (which may, in some embodiments, partially or completely surround the first region, as discussed above; thus, the third region may be an outer region that also surrounds an inner or first region). In some embodiments, the third region may prevent the second region from combining into contact with components (such as solder or other metals) outside of the wire, tape, or other structure. The third region of the wire or other structure may be in contact with the solder or other metal, or there may be additional regions between the third region and the solder or other metal.

As an example, in one set of embodiments, the third region may comprise copper. In one embodiment, the third region consists essentially of copper. In certain cases, at least 50%, at least 75%, at least 90%, at least 95%, at least 99%, or substantially all of the third region may comprise copper.

The third region may positioned directly adjacent to the second region, or there may be one or more intervening regions present between the second region and the third region. In addition, the third region may have any suitable thickness. For example, the third region may have an average cross-sectional thickness that is less than 10 micrometers, less than 8 micrometers, less than 7 micrometers, less than 6 micrometers, less than 5 micrometers, less than 4 micrometers, less than 3 micrometers, less than 2 micrometers, less than 1 micrometers, etc. The thickness of the third region may be the same or different than the second region. In some cases, the third region may have substantially uniform thickness, although in other cases, the third region may not have substantially uniform thickness.

As previously noted, even if the outer region of the wire or other structure comprises copper (or another noble metal, such as silver) and is in contact with the solder or other metal, in certain embodiments, the solder or other metal is unable to significantly remove or extract the copper or other metal from the third region of the wire or other structure. Accordingly, the concentration of copper or other metal within the third region may remain substantially homogenous.

As mentioned, according to certain aspects, the solder or other metal may be introduced into a cable or other article using a variety of techniques, such as those described herein.

In some cases, the article and/or structures contained within the article may help to define spaces that can be filled with the solder or other metal. For example, portions of the article and/or structures contained within the article may define voids, channels, slots, grooves, or the like. It should, of course, be appreciated any number of these may be present, and that the particular number can be selected to fit the needs of the particular application in which the cable or other article will be used. The voids, channels, slots, grooves, or the like may have any regular (e.g. rectangular, circular, triangular, square, etc.) or irregular cross-sectional shape. Further, depending upon the application, each of these may or may not have the same cross-sectional shape.

In some cases, some or all of these may contain solder or other metal. For instance, in some embodiments, some channels may have a spiral shape. As mentioned, the solder or other metal may partially or completely fill these, for example, such that at least 50%, at least 60%, at least 70%, at least 80%, at least 90%, at least 95%, or substantially all of the volume contains the metal.

The solder or other metal may be a solid at room temperature, and may be heated to cause it to liquefy. A variety of methods may be used for heating it, including resistive heating, placing it in a heated crucible, hot air heating, exposure to a flame, a torch, or another heat source, such as a soldering gun or a soldering ion. The solder or other metal may be heated to a temperature at least sufficient to cause it to melt, e.g., at temperatures of between 180° C. and 200° C., or other temperature ranges for the melting points as discussed herein. For instance, the solder or other metal may be heated to a temperature of at least 150° C., at least 180° C., at least 190° C., etc.

In some cases, the temperature of the solder or other metal may be maintained at temperatures sufficient to keep the solder or other metal liquid, for relatively long periods of time, e.g., at least 5 minutes, at least 10 minutes, at least 15 minutes, at least 30 minutes, at least 1 hour, at least 2 hours, at least 3 hours, at least 4 hours, at least 5 hours, etc. For instance, if the cable is relatively long, it may take a relatively long time to produce such long cables, during which time the temperature of the solder or other metal is kept sufficiently high to keep it liquid.

In addition, after being introduced, any technique may be used for cooling, including passive cooling (exposure to ambient temperatures) or active cooling techniques, such as increased air flow, refrigeration, or the like.

The following examples are intended to illustrate certain embodiments, but do not exemplify the full scope of the described concepts.

### EXAMPLE 1

In this example, solder is added to a cable having slots or channels to hold stacks of superconducting wires or “tapes.”

Although conventional Pb₄₀Sn₆₀ solder (40% Pb, 60% Sn) is one of the cheapest options for solders, Pb₄₀Sn₆₀ solder has solubility issues with both copper and silver (which may be present within the tape). For instance, a single HTS tape may be encased in a layer of silver and/or a layer of copper to protect and maintain the superconducting properties of the tape. The silver layer may prevent oxygen from diffusing out of the superconducting layer of the tape (notated at “REBCO” in FIG. 10) to prevent degradation of the tape performance. Similarly, the copper layer on the outside of the tape may act as an electrical and/or thermal “stabilizer.” This may allow a finite amount of current sharing in the copper when the superconducting layer becomes resistive. However, studies have shown that when the tape is embedded in a PbSn solder bath above 200° C., large portions of silver or copper may be removed or “extracted” from the tape, which can cause degradation of the tape or its performance.

Accordingly, this example illustrates that saturating the PbSn solder with copper (Cu) may prevent solubility and/or diffusion issues with the copper layers of the tape. This may be, for example, due to the decreased concentration gradient between the tape and the solder mixture. In addition, to protecting the copper layer, the solder may prevent tin exposure to the silver layer. This may be useful to preserve the superconducting performance of the tape when exposed to solder. Such techniques may be used, for example, to allow sufficient time to successfully solder long lengths of cable without degradation of superconducting performance, or for other applications such as those discussed herein. One example of such a solder is Sn₆₂Pb₃Cu₂ (62% Sn, 36% Pb, 2% Cu), which was used in mixtures for up to 3 hours at elevated temperatures in this example. However, longer times and/or other types of solder may also be used in other embodiments.

This example uses solder for soldering long lengths (hundreds of meters) of multiple PbSn coated tapes layered in a multi-tape stack. The solder is injected along a square channel inside of a copper structure with multiple stacks of tape. The solder fills in voids in the slot to ensure thermal and electrical contact of the tapes to the copper structure. This may help to optimize performance of the cable by enabling better current sharing, heat removal, and/or structural support.

Because this solder is used in long lengths of cable, the tape and the cable could potentially see elevated solder temperatures for long periods of times (e.g., 1-3 hours). Experiments using the Sn₆₂Pb₃₆Cu₂ composition have successfully soldered REBCO tapes for three hours without any major observed performance degradation, as discussed herein.

The Sn₆₂Pb₃₆Cu₂ solder can come in many forms (solder bar or solder wire) and it is commercially available. However, it has not previously been applied to soldering tapes (in a solder bath or a solder impregnation process) for long periods of time at elevated temperatures to mitigate performance degradation, as previously mentioned.

In some experiments, the solder was used during solder bath experiments with PbSn plated REBCO tapes. The tapes were exposed to the Sn₆₂Pb₃₆Cu₂ bath at 193° C. for different exposure times (e.g., 60 min to 210 min). The critical current was tested for all tapes before and after each exposure time to determine the superconductivity degradation.

Sn₆₂Pb₃₆Cu₂ can be applied to the tape stack in many ways. Sn₆₂Pb₃₆Cu₂ solder bars can be purchased commercially. The bars are then placed inside of a holding pot and elevated to temperatures above the liquidus point. Once in liquid form, the solder is injected into the copper cable channel with HTS tapes using the pressure impregnation process.

The solder mixture can also be used in wire form. The solder can be applied to tapes, for example, using a solder iron technique or a hot plate. As another example, thin strips of flattened solder wires can be pancaked in between stacks or above a stack. Once the tape stack is elevated to temperatures above the melting point, the solder may adhere all tapes to each other and fill in voids.

Different compositions may be used for Pb, Sn, and Cu in the solder mixture, e.g., in addition to the Sn₆₂Pb₃₆Cu₂ described in this example. The solder may have a relatively low melting point (e.g., 200° C. or less). In some cases, the solder composition may prevent, avoid, or at least minimize scavenging of a protective layer around a superconductor, e.g., silver and/or copper layers. This can be generalized to a variety of different superconducting protective layers and non-scavenging solder combinations. For example, having a low melting point and non-scavenging characteristics allows the superconductor to be held at elevated temperatures and times required for soldering it in long lengths without substantial degradation of superconducting performance.

While several embodiments of the concepts described herein have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the concepts described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the concepts described herein is/are used. Those skilled in the art will recognize, or be able to ascertain using no more than routine experimentation, many equivalents to the specific embodiments of the concepts described herein. It is, therefore, to be understood that the foregoing embodiments are presented by way of example only and that, within the scope of the appended claims and equivalents thereto, the described concepts may be practiced otherwise than as specifically described and claimed. The concepts described herein relate to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the concepts described herein.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment may include that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method, comprising:
inserting a high temperature superconductor (HTS) cable into a groove of a support structure; and
flowing a molten metal into the HTS cable while the HTS cable is in the groove.

2. The method of claim 1, wherein the molten metal is a molten solder and flowing the molten metal into the HTS cable comprises flowing the molten solder into the cable.

3. The method of claim 1, wherein the groove has a spiral shape and inserting the HTS cable into the groove comprises inserting the HTS cable into the groove having a spiral-shape.

4. The method of claim 1, further comprising cooling the molten metal to solidify the molten metal.

5. The method of claim 1, wherein the support structure is a first support structure and the method further comprises inserting a second HTS cable into a second groove of a second support structure and flowing a second molten metal into the second HTS cable while the second HTS cable is in the groove.

6. The method of claim 5, further comprising attaching the first support structure to the second support structure.

7. The method of claim 5, further comprising electrically connecting the HTS cable with the second HTS cable.

8. A magnet structure, comprising:
a support structure having a groove; and
a high temperature superconductor (HTS) cable comprising a metal at least partially filling the HTS cable, the HTS cable being disposed in the groove.

9. The magnet structure of claim 8, wherein the metal comprises solder.

10. The magnet structure of claim 8, wherein a shape of the HTS cable conforms to a shape of the groove.

11. The magnet structure of claim 8, wherein the HTS cable comprises at least one HTS tape stack.

12. The magnet structure of claim 8, wherein the HTS cable comprises a plurality of channels and a plurality of HTS tape stacks disposed in respective channels of the plurality of channels.

13. The magnet structure of claim 12, wherein the HTS cable comprises a former separating at least first and second HTS tape stacks of the plurality of HTS tape stacks.

14. The magnet structure of claim 13, wherein the former comprises an electrically conductive metal.

15. The magnet structure of claim 14, further comprising an electrical insulator insulating sections of the former from each other.

16. The magnet structure of claim 14, wherein the electrically conductive metal comprises copper or steel.

17. The magnet structure of claim 8, wherein the HTS cable comprises a cooling channel.

18. The magnet structure of claim 11, wherein the at least one HTS tape stack is twisted along a length of the HTS cable.

19. The magnet structure of claim 8, wherein the support structure comprises an electrically conductive material.

20. The magnet structure of claim 8, wherein the HTS cable has a spiral shape in the groove.

21. The magnet structure of claim 8, wherein the HTS cable has a plurality of turns, and respective turns of the plurality of turns are electrically coupled to one another through the support structure.

22. The magnet structure of claim 8, wherein the magnet structure is a first magnet structure and the magnet further comprises:
a second support structure having a second groove; and
a second HTS cable comprising a second metal at least partially filling the second HTS cable, the second HTS cable being disposed in the second groove,
wherein the HTS cable is electrically connected to the second HTS cable.

23. The magnet structure of claim 8, wherein the HTS cable comprises a jacket and an HTS tape within the jacket.

24. The magnet structure of claim 23, wherein the jacket and the HTS tape extend along a length of the HTS cable.

25. The magnet structure of claim 8, wherein the support structure comprises a plate.

26. The method of claim 1, wherein the HTS cable comprises an HTS tape stack that is arranged to slip along a length of the HTS cable when the HTS cable is inserted into the groove.

27. The method of claim 1, wherein flowing a molten metal into the HTS cable comprises flowing the molten metal into a channel of the HTS cable.
